(19) United States
(12) Patent Application Publication
(10) Pub. No.: US 2024/0406407 A1
(43) Pub. Date: Dec. 5, 2024

(54) METHOD AND APPARATUS FOR VIDEO CODING FOR REDUCING BLOCK BOUNDARY DISCONTINUITY

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(72) Inventors: Byeung Woo Jeon, Seongnam-si (KR); Bum Yoon Kim, Yongin-si (KR); Yu Jin Lee, Suwon-si (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(21) Appl. No.: 18/802,795

(22) Filed: Aug. 13, 2024

Related U.S. Application Data
(63) Continuation of application No. PCT/KR2023/001184, filed on Jan. 26, 2023.

(30) Foreign Application Priority Data
Feb. 24, 2022 (KR) 10-2022-0024383
Jan. 18, 2023 (KR) 10-2023-0007469

(51) Int. Cl. H04N 19/139; H04N 19/159; H04N 19/176

(52) U.S. Cl. CPC H04N 19/139; H04N 19/159; H04N 19/176

(57) ABSTRACT

A method and an apparatus for video coding for reducing block boundary discontinuity includes using additional neighboring pixels of the current block or additional pixels of a referenceable picture toward prediction techniques with no use of neighboring pixels. The video coding method and the apparatus improve the predictor of the current block.

### CROSS REFERENCE TO RELATED APPLICATIONS

This application is a continuation of International Application No. PCT/KR2023/001184 filed on Jan. 26, 2023, which claims priority to and the benefit of Korean Patent Application No. 10-2022-0024383 filed on Feb. 24, 2022, and Korean Patent Application No. 10-2023-0007649, filed on Jan. 18, 2023, the entire contents of each of which are incorporated herein by reference.

### TECHNICAL FIELD

The present disclosure relates to a video coding method and an apparatus for reducing block boundary discontinuity.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Techniques such as inter prediction, intra block copy (IBC), cross-component linear model (CCLM), and the like generate the predictor of the current block without using neighboring pixels. Compared to prediction techniques that involve using neighboring pixels, these techniques would suffer from more pronounced discontinuities at the boundaries of the prediction block. Therefore, there is a need for methods of reducing the discontinuities at the boundaries of the prediction block, which may occur when generating a predictor without using neighboring pixels.

### SUMMARY

The present disclosure seeks to provide a video coding method and an apparatus that use additional neighboring pixels of the current block or additional pixels of a referenceable picture toward prediction techniques involving no use of neighboring pixels. The video coding method and the apparatus reduce salient discontinuities at the boundaries of the prediction block to improve the predictor of the current block.

At least one aspect of the present disclosure provides a method performed by a video decoding device for predicting a current block. The method includes decoding from a bitstream motion information that is of the current block and includes a reference picture index of the current block and a motion vector of the current block. The method also includes generating a first predictor of the current block by performing an inter prediction based on the motion information of the current block. The method also includes generating a second predictor of the current block by using information on adjacent blocks of the current block and the motion information of the current block. The method also includes deriving weights for the first predictor and the second predictor by using the information of the adjacent blocks of the current block and the motion information of the current block. The method also includes generating a final predictor of the current block by weighted summing the first predictor and the second predictor by using the weights.

Another aspect of the present disclosure provides a method performed by a video encoding device for predicting a current block. The method includes determining motion information that is of the current block and includes a reference picture index of the current block and a motion vector of the current block. The method also includes generating a first predictor of the current block by performing an inter prediction based on the motion information of the current block. The method also includes generating a second predictor of the current block by using information on adjacent blocks of the current block and motion information of the current block. The method also includes deriving weights for the first predictor and the second predictor by using the information of the adjacent blocks of the current block and the motion information of the current block. The method also includes generating a final predictor of the current block by weighted summing the first predictor and the second predictor by using the weights.

Yet another aspect of the present disclosure provides a computer-readable recording medium storing a bitstream generated by a video encoding method. The video encoding method includes determining motion information that is of a current block and includes a reference picture index of the current block and a motion vector of the current block. The video encoding also method includes generating a first predictor of the current block by performing an inter prediction based on the motion information of the current block. The video encoding also method includes generating a second predictor of the current block by using information on adjacent blocks of the current block and motion information of the current block. The video encoding also method includes deriving weights for the first predictor and the second predictor by using the information of the adjacent blocks of the current block and the motion information of the current block. The video encoding also method includes generating a final predictor of the current block by weighted summing the first predictor and the second predictor by using the weights.

As described above, the present disclosure provides a video coding method and an apparatus for improving the predictor of the current block by using additional neighboring pixels of the current block or additional pixels of a referenceable picture toward prediction techniques involving no use of neighboring pixels. Thus, the video coding method and the apparatus, based on reducing salient discontinuities at the boundaries of the predicted block, improve video quality and increase video coding efficiency.

### BRIEF DESCRIPTION OF THE FIGURES

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIGS. 6A, 6B, and 6C are diagrams illustrating prediction techniques involving no use of neighboring pixels.

FIGS. 7A, 7B, and 7C are diagrams illustrating discontinuities at the boundaries of a predicted block.

FIG. 8 is a diagram illustrating neighboring pixels of the current block.

FIGS. 9, 10, and 11 are diagrams illustrating the distribution of the current block's neighboring blocks and prediction modes, in accordance with some embodiments of the present disclosure.

FIG. 12 is a diagram illustrating neighboring pixel lines of the current block.

FIGS. 13 and 14 are diagrams illustrating the distribution of the current block's neighboring blocks and prediction modes, according to other embodiments of the present disclosure.

FIG. 15 is a diagram illustrating MV-indicated locations within a region.

FIGS. 16, 17, 18, and 19 are diagrams illustrating the distribution of motion vector-indicated blocks within a region and their prediction modes, according to one embodiment of the present disclosure.

FIG. 20 is a diagram illustrating the inference of a representative mode from a motion vector direction.

FIGS. 21A and 21B are diagrams illustrating a prediction based on a motion vector direction.

FIGS. 22, 23, and 24 are diagrams illustrating the distribution of the current block's neighboring blocks and prediction modes, according to yet another embodiment of the present disclosure.

FIGS. 25 and 26 are diagrams illustrating the distribution of motion vector-indicated blocks within a region and their prediction modes, according to another embodiment of the present disclosure.

FIG. 27 is a diagram illustrating grouping methods with pixels in a predictor of the current block, according to at least one embodiment of the present disclosure.

FIG. 28 is a diagram illustrating weights for the current block's predictor and additional predictors, according to at least one embodiment of the present disclosure.

FIGS. 29 and 30 are diagrams illustrating grouping methods with pixels within a predictor of the current block, according to another embodiment of the present disclosure.

FIGS. 31 and 32 are diagrams illustrating where a block boundary discontinuity-relaxing filter is applied.

FIG. 33 is a diagram illustrating the size of the region subject to a block boundary discontinuity-relaxing filter.

FIG. 34 is a diagram illustrating a co-located block with the current block.

FIG. 35 is a diagram illustrating a co-located block in a reference block with the current block, according to at least one embodiment of the present disclosure.

FIG. 36 is a diagram illustrating co-located templates with a template of the current block, according to at least one embodiment of the present disclosure.

FIG. 37 is a diagram illustrating a predictor performing a current block prediction, according to at least one embodiment of the present disclosure.

FIG. 38 is a flowchart of a method performed by the video encoding device for predicting the current block, according to at least one embodiment of the present disclosure.

FIG. 39 is a flowchart of a method performed by the video decoding device for predicting the current block, according to at least one embodiment of the present disclosure.

FIG. 40 is a flowchart of a method performed by the video encoding device for predicting a current chroma block, according to at least one embodiment of the present disclosure.

FIG. 41 is a flowchart of a method performed by the video decoding device for predicting a current chroma block, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

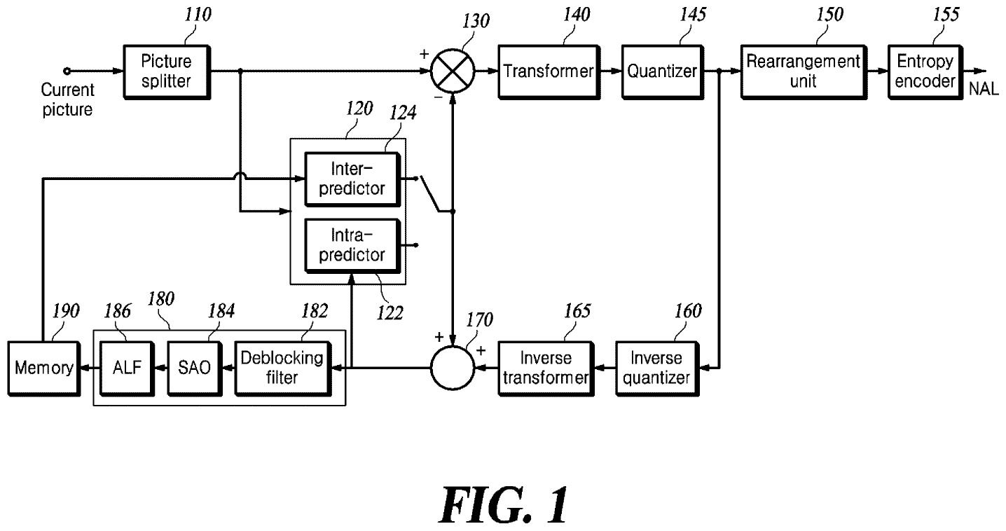

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

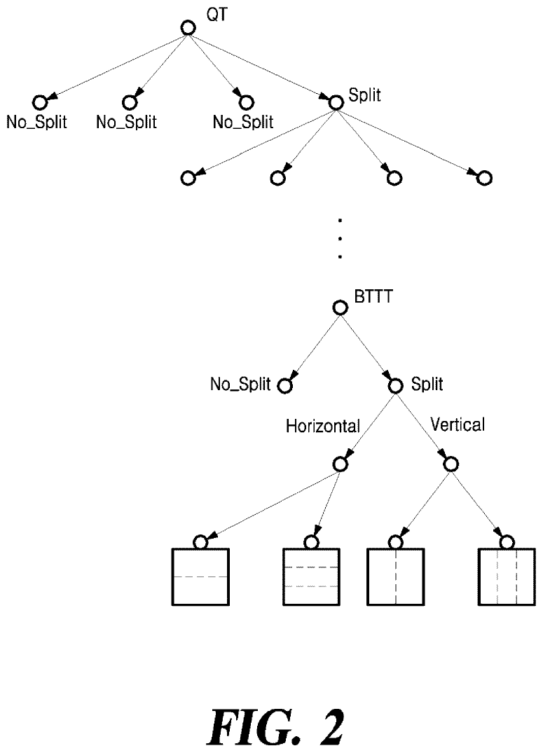

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

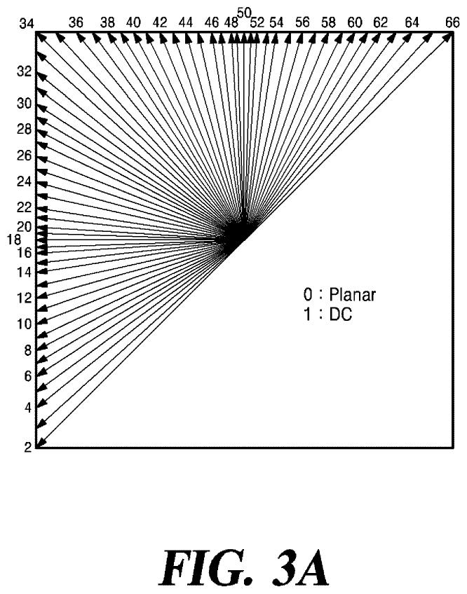

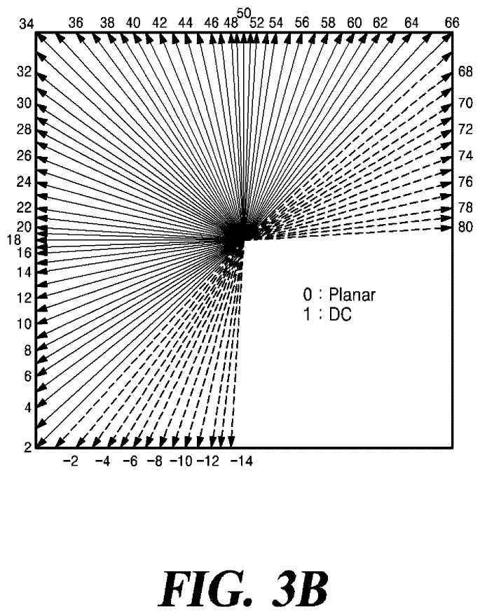

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than 135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

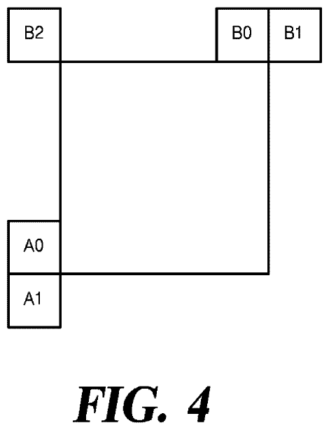

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

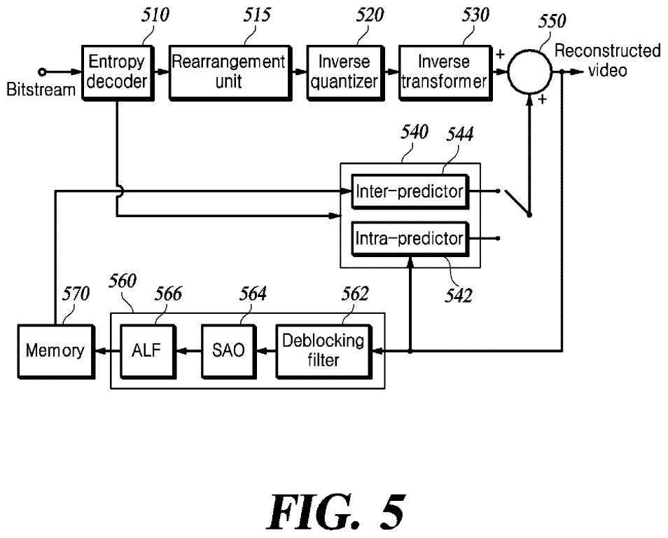

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, for prediction techniques that do not utilize neighboring pixels, the present disclosure provides a video coding method and an apparatus that improve the current block's predictor by additionally using neighboring pixels of the current block or pixels of a referenceable picture which can be referred to.

The following embodiments may be performed by the predictor 120 in the video encoding device. The following embodiments may also be performed by the predictor 540 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with predicting the current block.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

Additionally, the aspect ratio of a block is defined as the length of the block's horizontal dimension divided by the length of its vertical dimension.

### I. Prediction Techniques Involving No Use of Neighboring Pixels

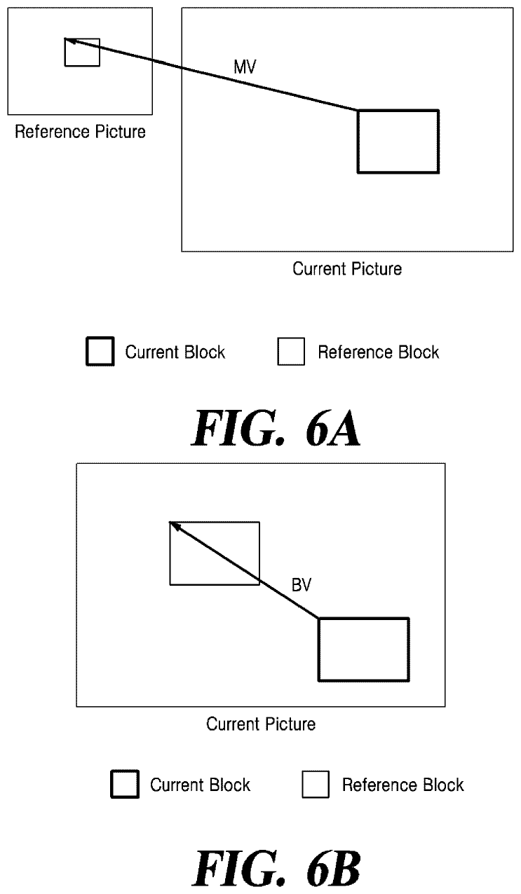

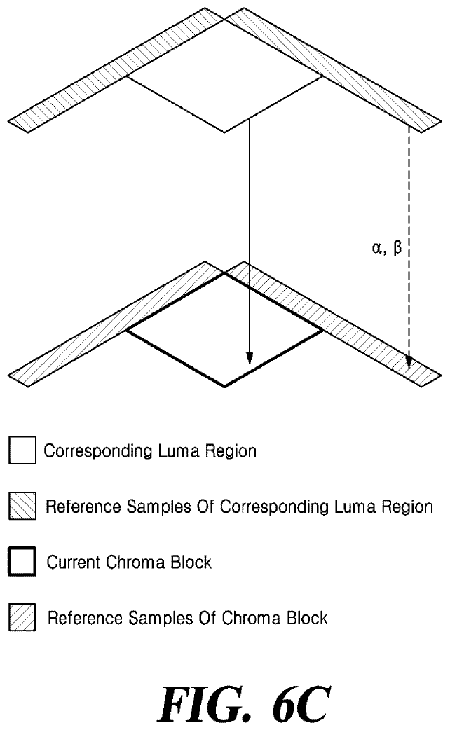

FIGS. 6A to 6C are diagrams illustrating prediction techniques involving no use of neighboring pixels.

As in the example of FIG. 6A, the inter-prediction technique searches for a reference block that is in an already decoded picture other than the current picture containing the current block and is most similar to the current block and uses the searched reference block as a predictor. The searched reference block may be signaled by using a reference picture index and a motion vector (MV). Additionally, the Intra Block Copy (IBC) technique as in the example of FIG. 6B searches for a reference block that is most similar to the current block within the reconstructed region of the current picture and uses the searched reference block as a predictor. The searched reference block may be signaled by using a block vector (BV). Additionally, the Cross-Component Linear Model (CCLM) technique as in the example of FIG. 6C is an intra-prediction technique for chroma components, which derives linear model coefficients (α, β) from the reference pixels of the current chroma block and the corresponding luma pixels. Then, the derived linear model is used to generate a predictor of the current chroma block from the corresponding luma regions. At this time, the positions of the corresponding luma pixels may be determined according to the CCLM mode.

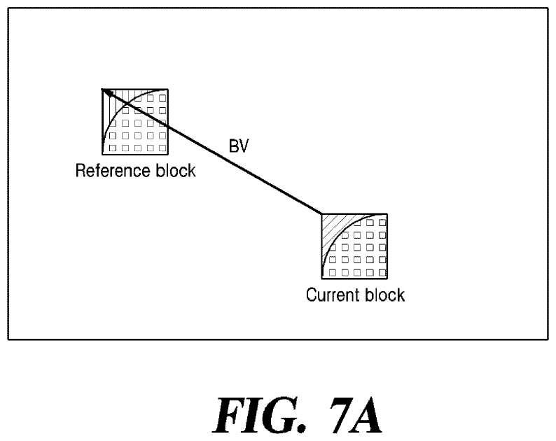

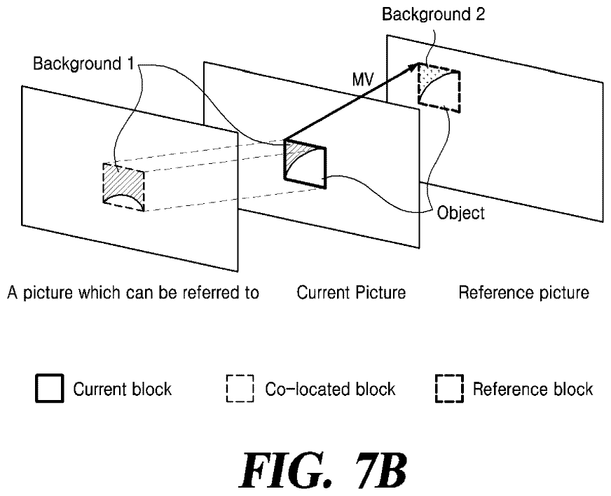

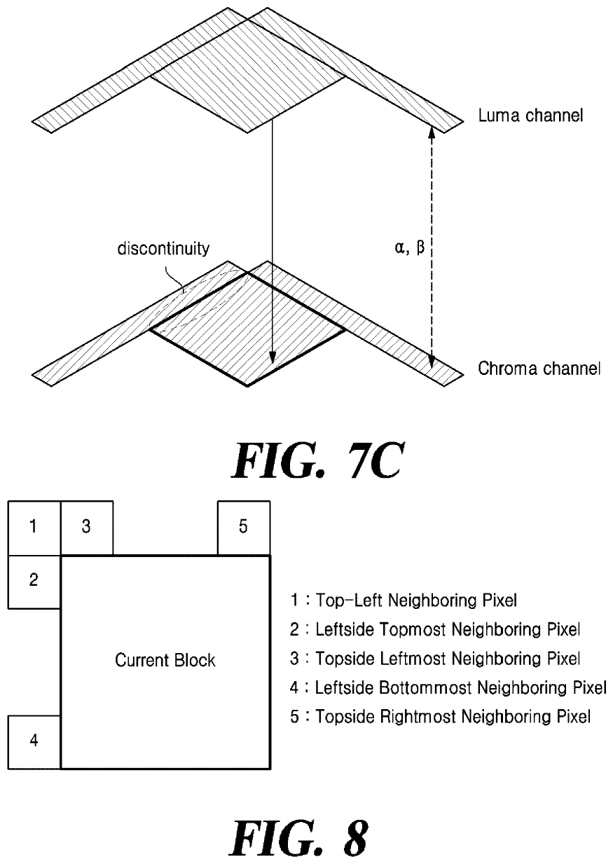

However, the above prediction techniques may suffer from deficiency in that discontinuities at the boundaries of the prediction block are more pronounced compared to prediction techniques by using neighboring pixels. In the IBC technique, since the reference block is searched based on its similarity to the current block, for example, searching for repeating patterns in the current picture, the correlation between the current block and its neighboring pixels is not reflected in the predictor generation. Therefore, discontinuities may occur, as shown in the example of FIG. 7A. Additionally, the inter-prediction technique performs an inter prediction by using a motion vector based on the motion of an object, which leaves a large residual signal after the inter prediction, mainly at the edges of the predicted block. This is because the background around the object often changes as the object moves. Therefore, discontinuities would occur in the region corresponding to the background within the current block, as shown in the example in FIG. 7B. Additionally, the CCLM technique, when a predictor is generated by applying a linear relationship to the corresponding luma region, does not take into account the correlation between the current block and its neighboring pixels. Therefore, discontinuities may occur, as shown in the example in FIG. 7C.

The present disclosure addresses the deficiencies of these prior art techniques by reducing block boundary discontinuities by utilizing adjacent pixels of the current block within the current picture. During inter prediction, a region that is in another referenceable picture and corresponds in location to the current block is likely to have the common background shared by the current block. Therefore, the co-located region with the current block, in another referenceable picture may be utilized to reduce discontinuities, as shown in the example of FIG. 7B.

Embodiments of reducing discontinuities at prediction block boundaries for inter prediction, IBC, and CCLM are described below. The following implementations are described about the video decoding device but may be performed similarly in the video encoding device.

### II. Implementations in the Inter-Prediction Case

### Implementation 1: Using Adjacent Pixels of the Current Block in the Current Picture

In this implementation, the video decoding device uses adjacent pixels of the current block in the current picture to remove discontinuities between the current block and the neighboring pixels. This may be accomplished by weighted summation of an inter-predictor and an additional predictor (Implementation 1-1), or by applying a filter to the expected location of the discontinuity (Implementation 1-2). Here, the inter-predictor represents a predictor of the current block generated based on the motion vector (MV).

### Implementation 1-1: Weighted Summation of Inter-Predictor and Additional Predictor

In this implementation, the video decoding device weighted-sums the inter-predictor and the additional predictor to generate a final predictor of the current block and thereby remove block boundary discontinuities. The additional predictor may be generated by performing intra-prediction on the current block by using adjacent pixels. The weighted summation may be expressed as shown in Equation 1.

$$pred ( i , j ) = w ( i , j ) \times {pred}_{inter} ( i , j ) + ( 1 - w ( i , j ) ) \times {pred}_{add} ( i , j ) \qquad Equation 1$$

Here, (i,j) represents a pixel position. ‘pred’ denotes the final predictor of the current block, ‘predᵢₙₜₑᵣ’ denotes an inter-predictor based on the motion vector, and ‘pred_{add}’ denotes an additional predictor according to the present embodiment. If multiple additional predictors are used, additional predictors besides ‘pred_{add}’ may be added to Equation 1, and the weights may be distributed for each of the additional predictors within (1−w(i,j)).

Hereinafter, the inter-predictor is used interchangeably with the first predictor, and the additional predictor is used interchangeably with the second predictor.

This implementation may vary in practice according to (Implementation 1-1-1) a method of generating additional predictors based on intra-predictions based on adjacent pixels, and (Implementation 1-1-2) a weighted summing method.

### Implementation 1-1-1: Generating Additional Predictors Based on Intra-Predictions Based on Adjacent Pixels

In this implementation, to perform the intra prediction based on adjacent pixels, the video decoding device autonomously infers a method of generating additional predictors or is signaled with information on the method of generating additional predictors. For this purpose, the present disclosure may use (Implementation 1-1-1-1) a method of inferring or signaling an intra-prediction mode, (Implementation 1-1-1-2) a new intra-prediction method, or (Implementation 1-1-1-3) a combined method of Implementation 1-1-1-1 and Implementation 1-1-1-2 to generate a plurality of additional predictors.

### Implementation 1-1-1-1: Intra-Predictor Mode Inferring or Signaling

In this implementation, the video decoding device derives the intra-prediction mode by using information on adjacent blocks of the current block in the current channel, information on blocks contained in the region indicated by the MV, information on neighboring blocks of the MV-indicated region, and/or the direction of the MV. Alternatively, the video decoding device uses a predefined or signaled intra-prediction mode. Here, the current channel may be a luma channel or a chroma channel.

In generating the additional predictor, the intra-prediction mode of the conventional VVC (Versatile Video Coding) may be used immediately without adding complex techniques. For example, the video decoding device sets the prediction mode of the additional predictor to one of the existing intra-prediction modes. At this time, the set prediction mode is expressed as a representative mode which may be determined as follows.

First, the video decoding device may use a predefined prediction mode as the representative mode. In this case, the prediction mode that can be used may be a mode that generates predictors based on neighboring pixels, such as 67 intra-prediction modes (IPMs) (as illustrated in FIG. 3A), matrix-weighted intra-prediction mode (MIP mode), or the like. For example, if the prediction mode of a single additional predictor is defined as planar mode, then Equation 1, which represents the final predictor for the current block, may be expressed as Equation 2.

$$pred ( i , j ) = w ( i , j ) \times {pred}_{inter} + ( 1 - w ( i , j ) ) \times {pred}_{planar} \qquad Equation 2$$

Second, the video decoding device may infer the representative mode from information on neighboring blocks adjacent to the current block in the current channel.

As one example, the video decoding device may use as the representative mode the intra-prediction mode of a block containing pixels at a specific location among the neighboring pixels of the current block. In this case, one or more of the locations 1 to 5 illustrated in FIG. 8, and any additional locations, may be selected as the specific location.

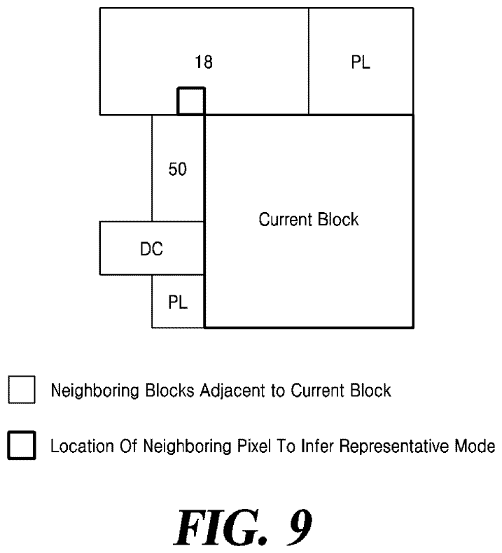

For example, the current block's neighboring blocks and prediction modes are assumed to be distributed as shown in the example of FIG. 9. The numbers in the blocks shown represent the prediction modes. When a representative mode is derived based on the neighboring pixel located at the top left (location 1 in the example of FIG. 8), the video decoding device uses mode 18 as the representative mode.

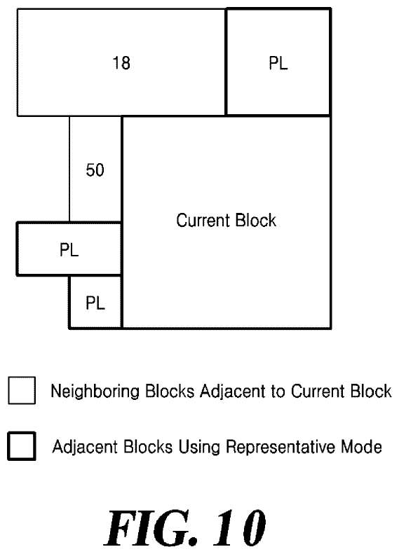

As another example, the video decoding device may derive the most frequent prediction mode based on a block count from among the intra-prediction modes of neighboring blocks adjacent to the current block and may use the most frequent prediction mode as the representative mode. For example, in the example of FIG. 10, if there are five adjacent blocks and three of the blocks use the planar mode, the video decoding device uses the planar mode as the representative mode.

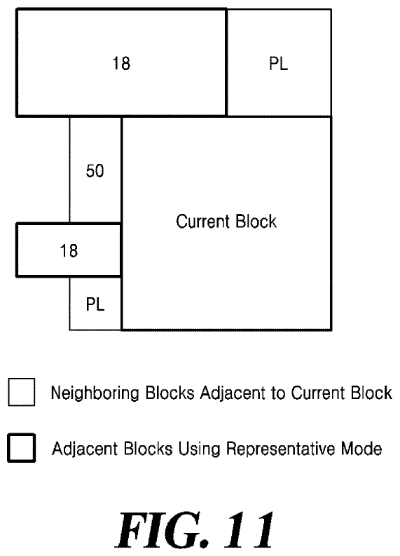

If there are more than two most frequent prediction modes, more than two most frequent prediction modes may be prioritized separately to derive the representative mode. In this case, a preset priority may be used, such as {planar, DC, horizontal mode, vertical mode, . . . }, in ascending or descending order. Alternatively, blocks in the relevant mode may be given a higher priority the closer the blocks are to the top left. For example, in the example of FIG. 11, if a higher priority is given to a block closer to the top left, the block in mode 18 has a higher priority since the block in mode 18 is closer to the top left than the block in planar mode. Therefore, the video decoding device derives the representative mode with mode 18. In addition to this, if there are more than two most frequent prediction modes, the representative mode may be derived based on a predefined rule.

As yet another example, the video decoding device may derive the most frequent prediction mode based on block area among intra-prediction modes of neighboring blocks of the current block and may use the most frequent prediction mode as a representative mode. In this implementation, the video decoding device may use the block area in place of the number of blocks when the most frequent prediction mode is derived.

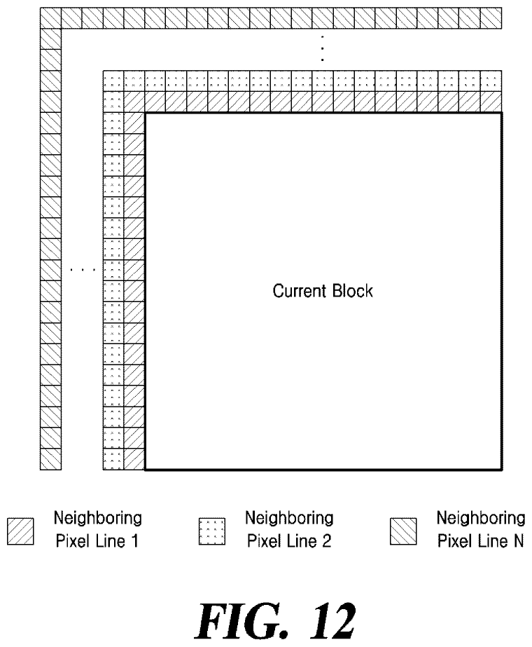

As yet another example, the video decoding device may derive the most frequent prediction mode based on the intra-prediction mode of the block containing each neighboring pixel of the current block and may use the most frequent prediction mode as a representative mode. In addition to pixels simply adjacent to the current block, also considered may be pixels on a neighboring pixel line somewhat distanced from the current block, as in the example of FIG. 12. The video decoding device may select only one of the plurality of neighboring pixel lines, select two or more neighboring pixel lines, or utilize such various combinations. Furthermore, when the predictor is generated with intra prediction, if the generation of neighboring pixels happens to use a method such as padding for no necessary neighboring pixels being present, the video decoding device may take into account only the originally present neighboring pixels, excluding the padded neighboring pixels.

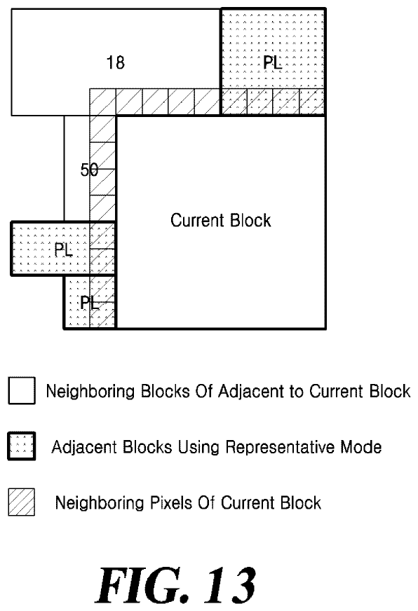

For example, a case is assumed where only a neighboring pixel line is used immediately adjacent to the current block. In the example of FIG. 13, of the 17 neighboring pixels, including the 16 neighboring pixels adjacent to the left and top of the current block and the one neighboring pixel at the top left, there is the largest number of 8 pixels that use the planar mode. Therefore, the video decoding device uses the planar mode as a representative mode.

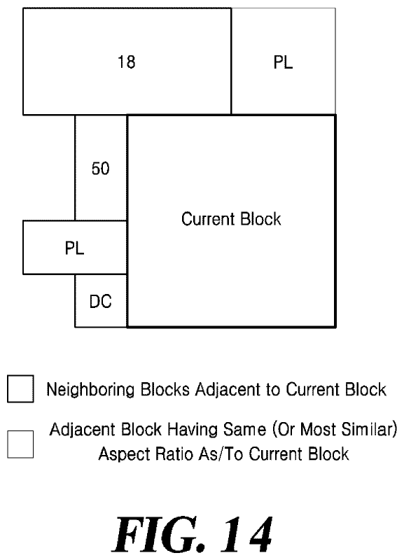

As yet another example, the video decoding device may use as the representative mode the intra-prediction mode of the neighboring blocks of the current block that have the same (or most similar) aspect ratio as the current block. For example, when the current block's neighboring blocks and prediction modes are distributed as shown in the example in FIG. 14, the prediction modes of blocks with the same aspect ratio as the current block are planar mode and DC mode. If multiple prediction modes were derived, the prediction mode of the block with the largest size may be used as the representative mode. Therefore, the video decoding device uses the planar mode as the representative mode in this example.

Third, the video decoding device may infer the representative mode from information on a neighboring block in the MV-indicated region. This method is the same as ‘inferring a representative mode from information on the neighboring block of the current block in the current channel’ with the current block replaced by ‘the MV-indicated region’.

Fourth, the video decoding device may infer the representative mode from information on the block contained in the MV-indicated region. In this case, the current block's MV-indicated region is equivalent to the reference block.

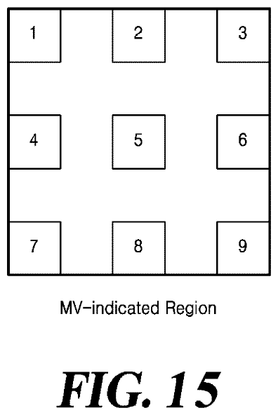

In one example, the video decoding device may use as the representative mode the intra-prediction mode of a block that includes pixels at a specific location within the current block's MV-indicated region. In this case, one or more of the various locations within the MV-indicated region may be designated as the specific location(s), as shown in the example of FIG. 15.

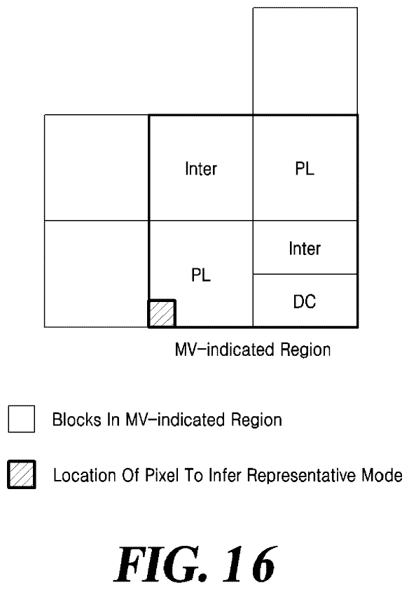

For example, with the blocks and prediction modes distributed in the MV-indicated region as shown in the example of FIG. 16, a representative mode may be derived based on the pixel located at the bottom left (location 7 in the example of FIG. 15). In this case, the video decoding device uses the planar mode as the representative mode.

As another example, the video decoding device may derive the most frequent intra-prediction mode based on the block count among the intra-prediction modes of the blocks in the current block's MV-indicated region and may use the most frequent intra-prediction mode as the representative mode.

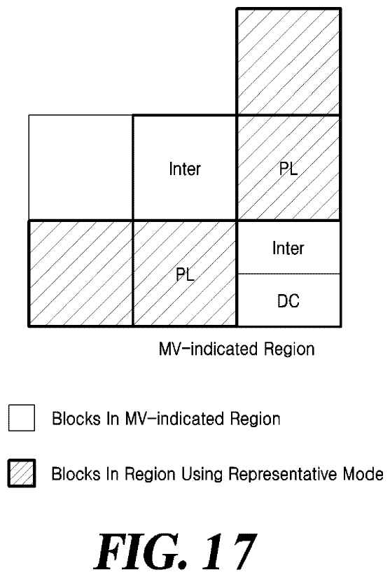

With the blocks and prediction modes distributed in the MV-indicated region as shown in the example of FIG. 17, there are a total of five blocks, two of which use the planar mode. Therefore, the video decoding device uses the planar mode as a representative mode.

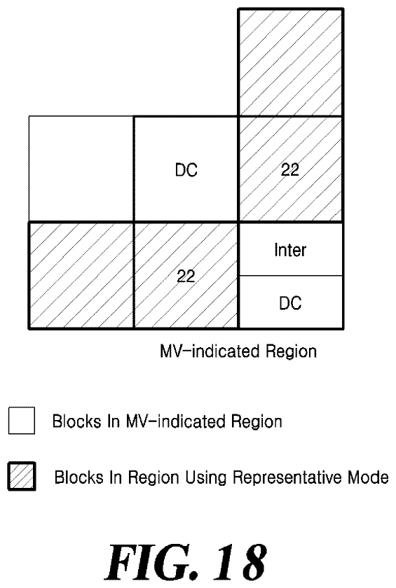

If there are more than two most frequent modes, a representative mode may be derived by prioritizing more than two most frequent modes separately. In this case, a preset prioritization such as {Planar, DC, Horizontal mode, Vertical mode, . . . }, in ascending or descending order, may be used. Alternatively, blocks in a given mode may be given a higher priority as the blocks occupy a larger area within the MV-indicated region. For example, in the example of FIG. 18, where a block in a given mode is given a higher priority as the block occupies a larger area within the MV-indicated region, the block in mode 22 has a higher priority because the block in mode 22 occupies a larger area within the region than the block in DC mode. Therefore, the video decoding device derives the representative mode with mode 22. Besides, if there are more than two most frequent prediction modes, the representative mode may be derived based on a predefined rule.

As yet another example, the video decoding device may derive the most frequent prediction mode based on the block area among the intra-prediction modes of the blocks in the current block's MV-indicated region and may use the most frequent prediction mode as a representative mode. In this implementation, when the most frequent prediction mode is derived, the video decoding device uses the block area in place of the number of blocks.

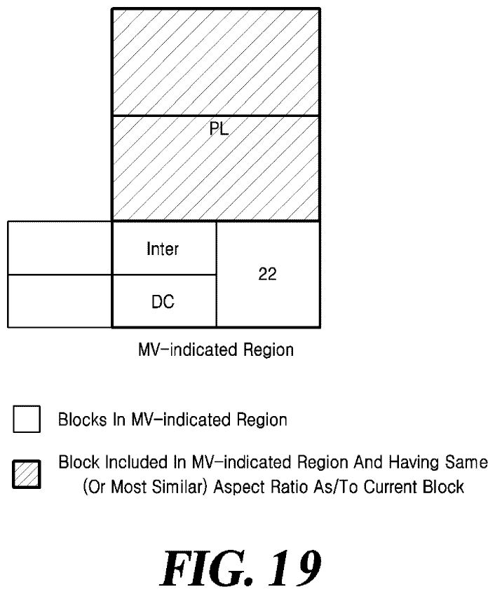

As yet another example, the video decoding device may use as the representative mode the intra-prediction mode of the block that is among blocks in the current block's MV-indicated region and has the same (or most similar) aspect ratio as the current block. For example, with the blocks and prediction modes distributed in the MV-indicated region as shown in the example of FIG. 19, the prediction modes of blocks having the same aspect ratio as the current block are planar mode and mode 22. If multiple prediction modes were derived, the prediction mode of the block with the largest size may be used as the representative mode. Therefore, the video decoding device uses the planar mode as the representative mode in this example.

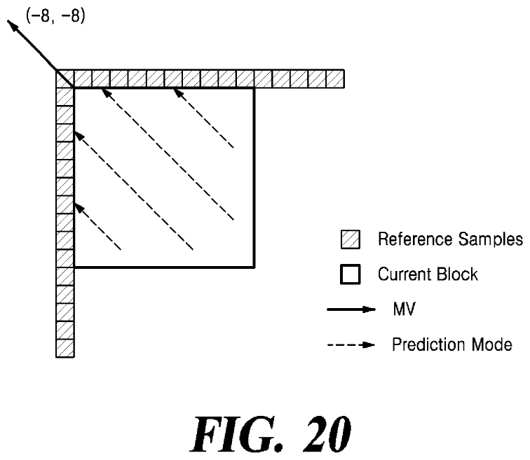

Fifth, the video decoding device infers the representative mode from the direction of the MVs. The video decoding device may derive as the representative mode the intra-prediction mode that is most similar in direction to the MV of the current block. For example, as shown in the example of FIG. 20, if the MV of the current block is given as (−8,−8), the intra-prediction mode most similar in direction to the MV is the top-left diagonal mode (mode 34). Therefore, the video decoding device uses mode 34 as a representative mode.

Sixth, the video decoding device does not infer a representative mode to use for generating additional predictors but uses a parsed representative mode after receiving the signal from the video encoding device.

### Implementation 1-1-1-2: Using a New Intra-Prediction Method

In this implementation, the video decoding device generates additional predictors by using reference pixels in the MV direction or using a deep learning-based neural network. The predictor generation methods for use here may be different from the existing intra-prediction methods and may include the following methods.

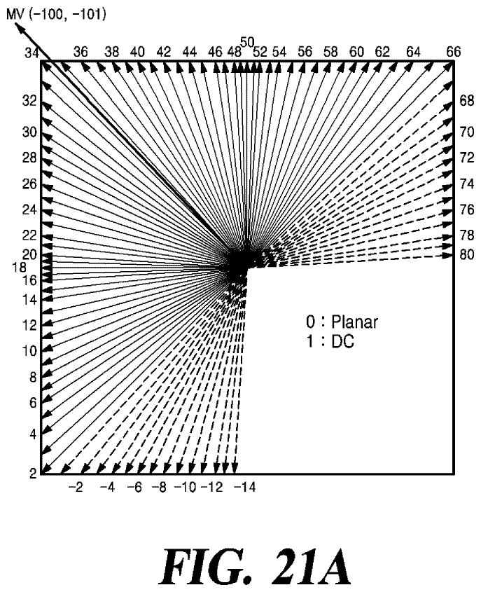

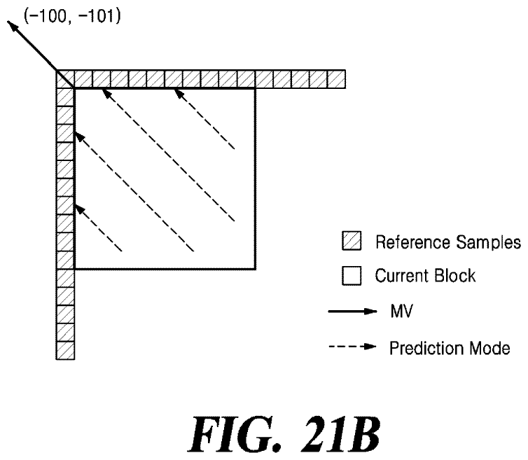

First, the video decoding device may generate additional predictors according to the principle of intra prediction by taking in reference pixels from the direction of the MV of the current block. With this method, the predictors may be generated according to a more precise prediction direction than the method described above of inferring a representative mode from the direction of the MV. For example, if an MV is given as (−100,−101), its direction is located between modes 34 and 35, as shown in the example of FIG. 21A. Since there is no intra-prediction mode that can accurately represent the direction of such an MV, the above implementation arranges the direction of such an MV to be approximated to the intra-prediction mode in the closest direction. However, this implementation represents the prediction mode as an MV as shown in FIG. 21B, which allows the video decoding device to generate a predictor based on a more precise prediction direction.

Second, the video decoding device may generate additional predictors by using a neural network with the current block's neighboring pixels as input. In this case, the neural network is pre-trained to generate additional predictors. Further, a single neural network may be used steadily, or there may be multiple neural networks to have one determined and used in response to a signal.

### Implementation 1-1-1-3: Implementation 1-1-1-1 and Implementation 1-1-1-2 Combined

In this implementation, the video decoding device may combine the methods of Implementation 1-1-1-1 and Implementation 1-1-1-2 to generate a plurality of predictors based on neighboring pixels of the current block. If there are two additional predictors, two additional predictors may be weighted and summed as shown in Equation 3.

$$pred ( i , j ) = w ( i , j ) \times {pred}_{inter} ( i , j ) + ( 1 - w ( i , j ) ) \times \{ {w}_{1} \times {pred}_{add 1} + {w}_{2} \times {pred}_{add 2} \} \qquad Equation 3$$

Here, w₁+w₂=1.

To generate the additional predictors, the video decoding device may use any of the methods described above, or may generate a plurality of predictors by using a different method for each predictor. For example, when two additional predictors of planar mode that is a predefined conventional intra prediction technique and VER(50) mode that is a prediction mode most closely resembling the direction of the MV of the current block are used, the final predictor of the current block is represented by Equation 4.

$$pred ( i , j ) = w ( i , j ) \times {pred}_{inter} ( i . j ) + ( 1 - w ( i , j ) ) \times \{ {w}_{1} \times {pred}_{planar} + {w}_{2} \times {pred}_{VER} \} \qquad Equation 4$$

The present disclosure envisions many other combinations than the above combined methods, and as the number of additional predictors increases, a more diverse combination of additional predictor generation methods may be provided.

### Implementation 1-1-2: Weighted Summation of Inter-Predictors and Additional Predictors

This implementation relates to a method of weighted summation of the inter-predictor of the current block and additional predictors. The video decoding device applies the weight setting method of each predictor to the case where there is one additional predictor besides the predictor according to the inter prediction, but the same method may be applied to the case where there are multiple additional predictors. Among the following weighted summing methods, Implementations 1-1-2-1 through 1-1-2-3 set equal weights for pixels within a predictor, and thus Implementations 1-1-2-1 through 1-1-2-3 use Equation 5, which excludes the influence of pixel coordinates (i,j) within the predictor.

$$pred = w \times {pred}_{inter} + ( 1 - w ) \times {pred}_{add} \qquad Equation 5$$

Additionally, Implementation 1-1-2-4 sets different weights depending on pixel coordinates (i,j) within the predictor, so Implementation 1-1-2-4 uses Equation 1 as it is.

### Implementation 1-1-2-1: Using a Pre-Defined Weight

In this implementation, the video decoding device uses a predefined weight w. In this case, an even weight may be used or a high weight (e.g., 3:1, 7:1, and the like) for the current block's inter-predictor may be used.

For example, an equal weight may be set for all predictors, as shown in Equation 6.

$$pred = \frac{1}{2} \times {pred}_{inter} + \frac{1}{2} \times {pred}_{add} \qquad Equation 6$$

$$( w = \frac{1}{2} )$$

Alternatively, a high weight may be set for a predictor generated according to the current block's prediction method, inter prediction, as shown in Equation 7.

$$pred = \frac{3}{4} \times {pred}_{inter} + \frac{1}{4} \times {pred}_{add} \qquad Equation 7$$

$$( w = \frac{3}{4} )$$

Implementation 1-1-2-2: Deriving a Weight from Information on Neighboring Blocks of the Current Block

In this implementation, the video decoding device derives a weight w from information on neighboring blocks of the current block. The weight w may be derived according to any of the following methods.

First, the video decoding device derives the proportion of the current block's adjacent blocks that use the representative mode based on the number of blocks or block count to derive the weight w as shown in Equation 8.

$$w = 1 - \frac{Number of Blocks Using Representative Mode}{Total Number of Adjacent Blocks} \qquad Equation 8$$

Here, w represents the weight of the inter-predictor of the current block.

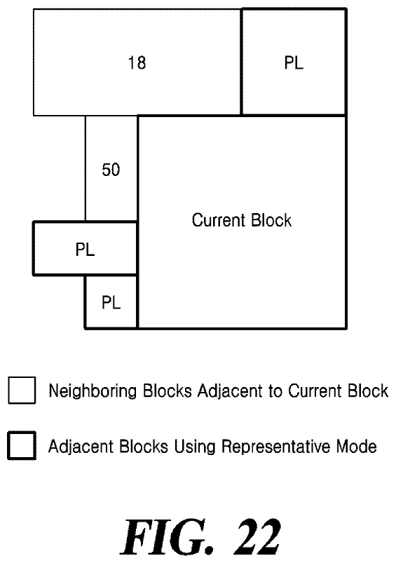

For example, when the current block's adjacent blocks and prediction modes are distributed as shown in the example of FIG. 22, the total number of adjacent blocks is 5 among which 3 is the number of adjacent blocks using the representative mode, planar mode. Therefore, the video decoding device may set 3/5 as the weight for the additional predictor and may set 2/5 as the weight for the inter-predictor.

Second, the video decoding device derives the proportion of the current block's adjacent blocks that use the representative mode based on the block area to derive a weight w, as shown in Equation 9.

$$w = 1 - \frac{Area of Blocks Using Representative Mode}{Total Area of Adjacent Blocks} \qquad Equation 9$$

Here, w represents the weight of the inter-predictor of the current block.

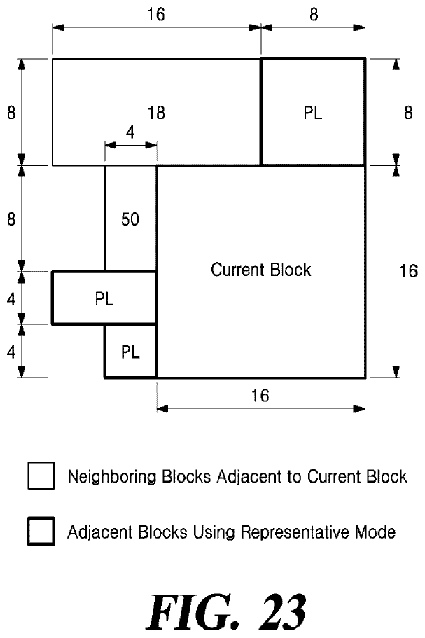

For example, when the current block's adjacent blocks and prediction modes are distributed as shown in the example of FIG. 23, the total area of the adjacent blocks is 272, 112 of which is the area of the adjacent blocks using the representative mode, planar mode. Therefore, the video decoding device may set 112/272 as the weight for the additional predictor and may set 160/272 as the weight for the inter-predictor.

Third, the video decoding device derives the proportion of the current block's adjacent blocks that use the representative mode based on the lengths of contacting sides between the current block and the adjacent blocks to derive a weight w as shown in Equation 10.

$$w = 1 - \frac{\begin{matrix}Length of Side Adjacent to Blocks \\ Using Representative Mode\end{matrix}}{Total Length of Side Adjacent to Current Block} \qquad Equation 10$$

Here, w represents the weight of the inter-predictor of the current block.

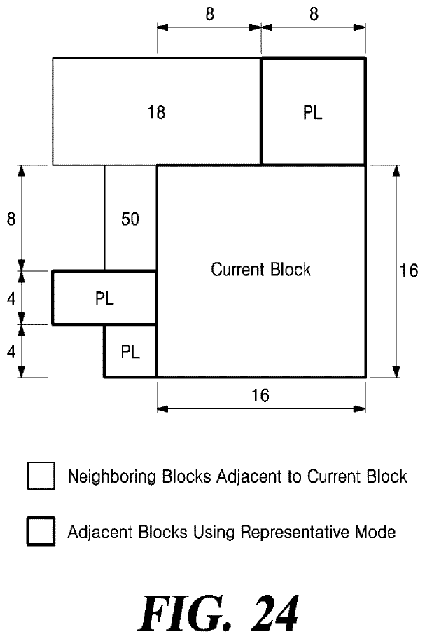

For example, when the current block's adjacent blocks and prediction modes are distributed as shown in the example of FIG. 24, the total length of contacting sides between the current block and its adjacent blocks is 32, 16 of which is the length of the contacting sides between the current block and its adjacent blocks using the representative mode of planar mode. Therefore, the video decoding device may set 16/32 as the weight for the additional predictors and set 16/32 as the weight for the inter-predictor.

Further, when a plurality of predictors are weighted summed in the above methods, the video decoding device may calculate the weight of each additional predictor in the same way, and may set the value generated by subtracting from 1 the sum of the weights for the additional predictors as the weight of the inter-predictor.

On the other hand, in the above methods, if the number of total adjacent blocks, the area of total adjacent blocks, or the length of the sides of total adjacent blocks is not in the form of a power of two, the hardware implementation may encounter significantly increased computational complexity of the division process. To avoid the increased complexity, the weights may be approximated to the powers of two for each denominator and numerator during the weighted summing process by using an operation such as Equation 11, and then the weights may be derived.

$$Number of Adjacent blocks Approximated = ( Number of Adjecent Blocks ) << 1 \qquad Equation 11$$

$$Area of Adjacent blocks Approximated = ( Area of Adjecent Blocks ) << 1$$

Implementation 1-1-2-3: Deriving Weights from Information on the Blocks within the MV-Indicated Region

In this implementation, the video decoding device derives a weight w from information on the blocks contained in the current block's MV-indicated region. The weight may be derived according to any of the following methods.

First, the video decoding device derives the proportion of blocks that use the representative mode among the blocks included in the current block's MV-indicated region, based on the block count, to derive the weight w, as shown in Equation 12.

$$w = 1 - \frac{Number of Blocks Using Representative Mode}{\begin{matrix}Total Number of Blocks in Region , \\ Indicated by MV\end{matrix}} \qquad Equation 12$$

Here, w represents the weight of the inter-predictor of the current block.

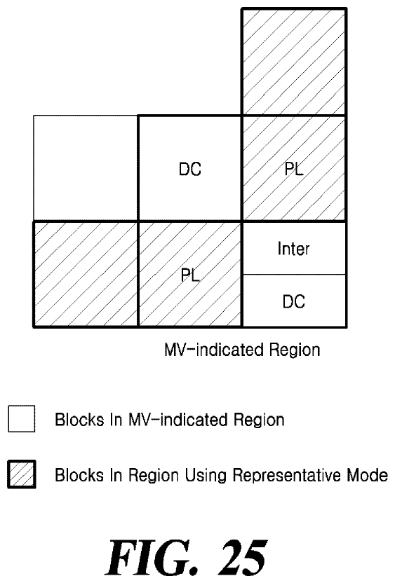

For example, with the blocks and prediction modes distributed in the MV-indicated region as shown in the example of FIG. 25, the total number of blocks included in the MV-indicated region is 5, 2 of which is the number of blocks using the representative mode, planar mode. Therefore, the video decoding device may set 2/5 as the weight for the additional predictor and may set 3/5 as the weight for the inter-predictor.

Second, the video decoding device derives, based on the block area, the proportion of blocks that use the representative mode among the blocks included in the MV-indicated region based on the block area to derive a weight w as shown in Equation 13.

$$w = 1 - \frac{Overlapping Area with Representative Mode Blocks}{Area of Block Indicated by MV} \qquad Equation 13$$

Here, w represents the weight of the inter-predictor of the current block.

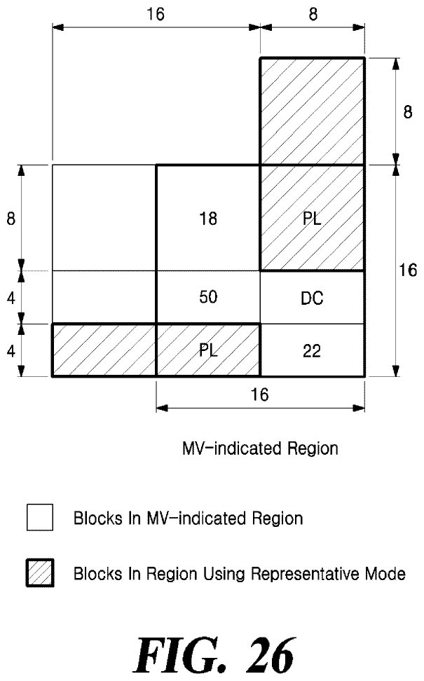

For example, with the blocks and prediction modes distributed in the MV-indicated region as shown in the example of FIG. 26, the total area of the current block's MV-indicated region is 256, 96 of which is the area overlapped with the MV-indicated region by the blocks using the representative mode, planar mode. Therefore, the video decoding device may set 96/256 as the weight for the additive predictors and may set 160/256 as the weight for the inter-predictor.

Further, when performing the weighted summation of a plurality of predictors in the above methods, the video decoding device may calculate the weight for each additional predictor in the same way, and may set the value generated by subtracting from 1 the sum of the weights for the additional predictors as the weight of the inter-predictor.

On the other hand, in the above methods, if the number of total blocks or the area of total blocks is not in the form of a power of two, the hardware implementation may encounter significantly increased computational complexity of the division process. To avoid this increased complexity, the weights may be approximated to the powers of two for each denominator and numerator by using an operation such as Equation 11, and then the weights may be derived.

### Implementation 1-1-2-4: Setting Weights According to the Location of the Pixel in the Current Block

In this implementation, the weights are set for each pixel within the predictor, as opposed to the previous three implementations where the same weights are set for the entire predictor. To set weights per pixel, separate weights may be set for each pixel, but it may be more effective to group pixels and then may set weights for each group.

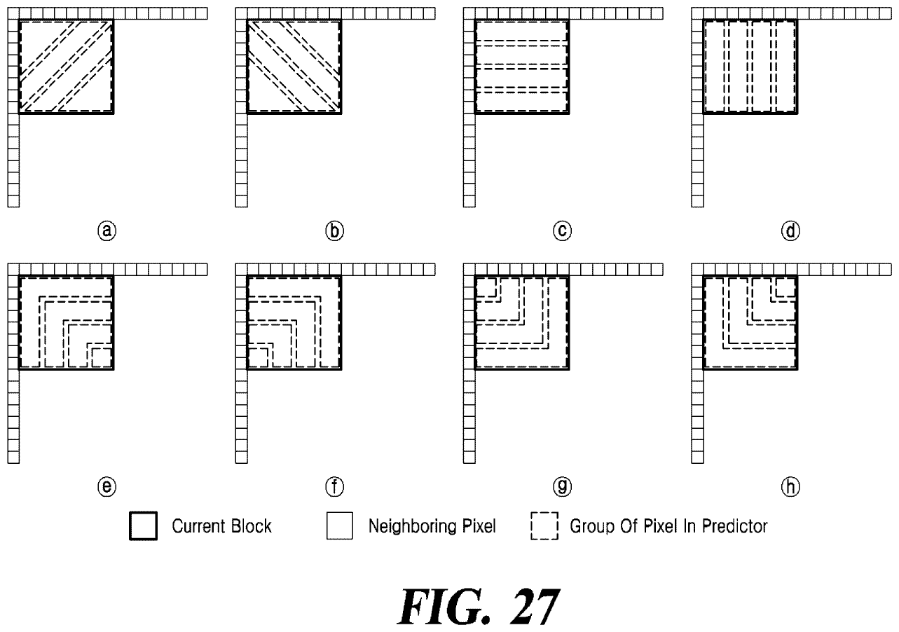

Thus, in this implementation, the video decoding device groups the pixels in the predictor and sets a weight for each group. The pixels in the predictor may be grouped according to various grouping methods, as illustrated in FIG. 27. In the example in FIG. 27, four groups are used for each method, but the number of groups may vary depending on the size, shape, and the like of the block. The grouping method may be inferred or signaled. First, the inferring of a grouping method is as follows.

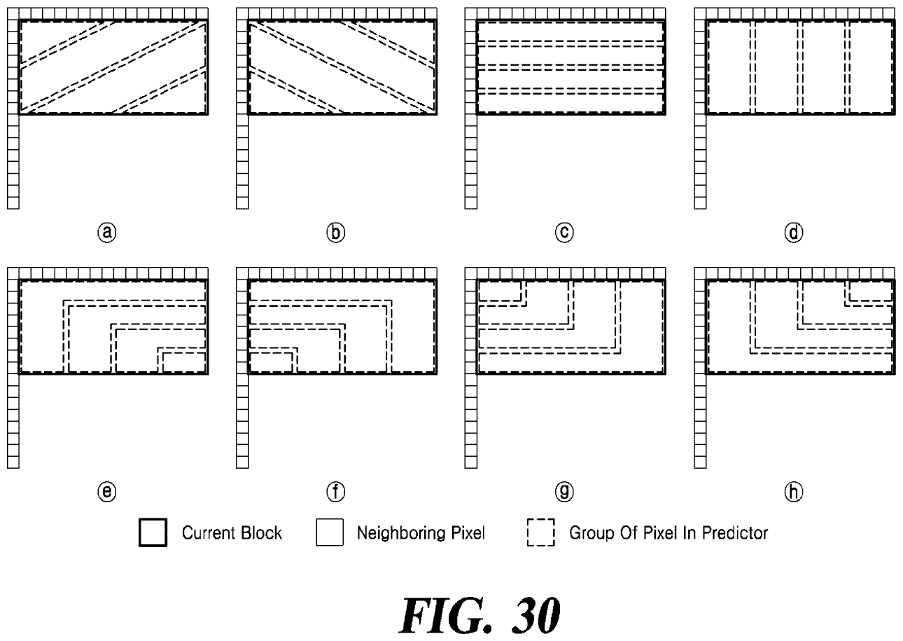

The video decoding device may steadily use one of the grouping methods of [symbol] - [symbol] in FIG. 27 to group the pixels or may determine the grouping method based on a representative mode. For example, grouping methods such as [symbol] , [symbol] , and [symbol] in FIG. 27 may be used for prediction modes that use both top neighboring pixels and left neighboring pixels (e.g., planar mode, DC mode, and prediction modes between 19 and 49). Further, grouping methods such as [symbol] , [symbol] , and [symbol] in FIG. 27 may be used for prediction modes that use only the left neighboring pixels (e.g., prediction modes 18 and below, DC mode, and the like). Additionally, grouping methods such as [symbol] , [symbol] , and [symbol] in FIG. 30 may be used for prediction modes that use only the top neighboring pixels (e.g., prediction modes 50 and above, DC mode, and the like).

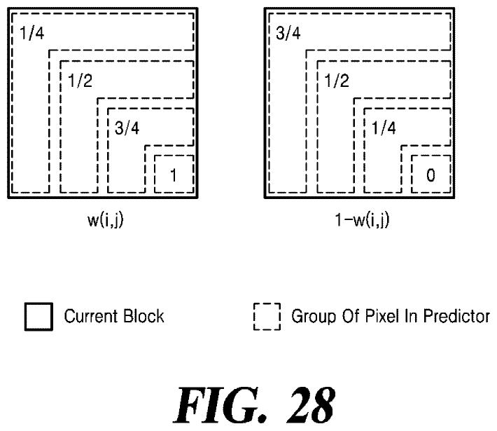

The video decoding device may set weights for each group of pixels by considering their distance from neighboring pixels. For example, the weights for the inter-predictor may be set to be larger the farther away from the neighboring pixels, and the weights for the additional predictors generated according to the representative mode may be set to be smaller the farther away from the neighboring pixels. When the pixels are grouped by the method of e in FIG. 27, the weights for the inter-predictor and the additional predictor may be set as shown in the example of FIG. 28. In this case, the predictor pred(0,0) for location (0,0) of the current block may be calculated as shown in Equation 14.

$$pred ( 0 , 0 ) = ( \frac{1}{4} {pred}_{inter} ( 0 , 0 ) + \frac{3}{4} {pred}_{add} ( 0 , 0 ) ) \qquad Equation 14$$

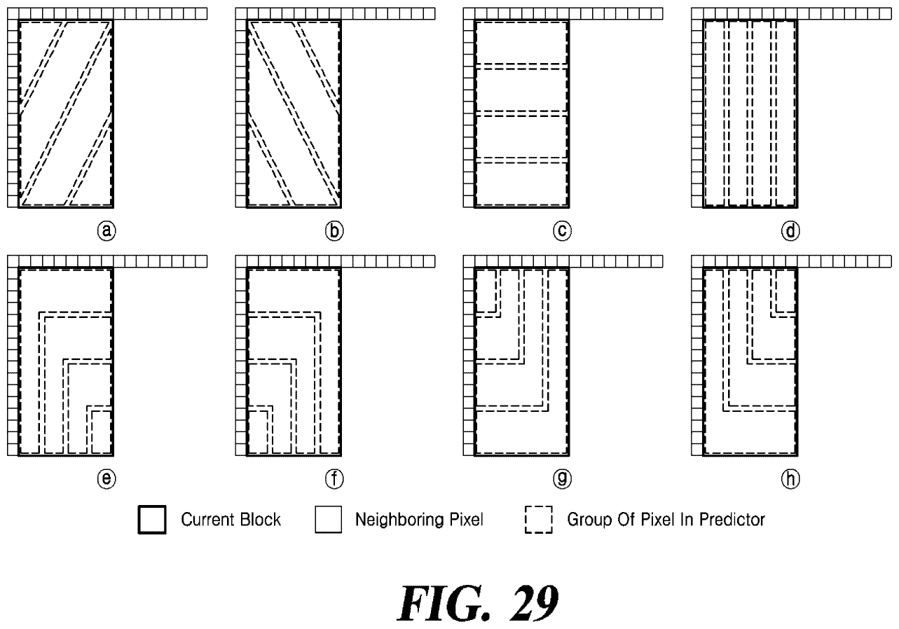

The examples of FIG. 27 illustrate grouping methods when the current block is square. If the current block is rectangular, the grouping methods illustrated in FIG. 27 may be modified and used for a rectangular block. For example, the example of FIG. 29 illustrates grouping methods for a rectangular block with a height greater than a width, and the example of FIG. 30 illustrates grouping methods for a rectangular block with a width greater than a height.

### Implementation 1-1-2-5: Signaling Weights

In this implementation, the video decoding device uses weights after being signaled about thereof as being related to either the method of setting the same weight for all pixels in a block to perform weighted-summation or the method of grouping pixels in a block and setting the weight for the grouped to perform weighted-summation. If the grouping method is used, the video decoding device first parses the grouping method and then parses the weights for each group.

### Implementation 1-2: Applying a Filter at the Expected Location of a Discontinuity Occurrence

In this implementation, the video decoding device applies a block boundary discontinuity-relaxing filter to remove discontinuities at the boundaries of the current block and neighboring blocks. The block boundary may represent the boundary of both the current block and neighboring blocks, but in the following description, only the edge region of the current block's predictor is referred to as the block boundary. When the filter is applied to any pixel located at the block boundary, the values of neighboring pixels outside the current block are used in the calculation of the pixel values inside the current block, so that the features of the neighboring pixels may be reflected in the current block's predictor. For this purpose, the following describes (Implementation 1-2-1) determining the type of block boundary discontinuity-relaxing filter, (Implementation 1-2-2) determining the location for applying the block boundary discontinuity-relaxing filter, and (Implementation 1-2-3) determining the size of the region subject to the block boundary discontinuity-relaxing filter.

### Implementation 1-2-1: Determining the Type of Block Boundary Discontinuity-Relaxing Filter

In this implementation, the video decoding device determines the type of block boundary discontinuity-relaxing filter. The relaxing filter may be determined according to any of the following methods.

First, the video decoding device may apply a predefined filter to the boundary where the discontinuity occurs. In this case, the applicable filter may be an n-tap filter, a cubic filter, a gaussian filter, or the like. The coefficients of the filter may also be predefined. For example, when applying a 3-tap filter, the coefficients of the filter may be pre-set to [1 2 1].

Second, the type of filter applied to the boundary where the discontinuity occurs may be signaled. The video decoding device may determine the type of filter by parsing, on a block basis, an index indicating one of a plurality of filters, including an n-tap filter, a cubic filter, a Gaussian filter, and the like.

### Implementation 1-2-2: Determining the Location for Applying Block Boundary Discontinuity-Relaxing Filter

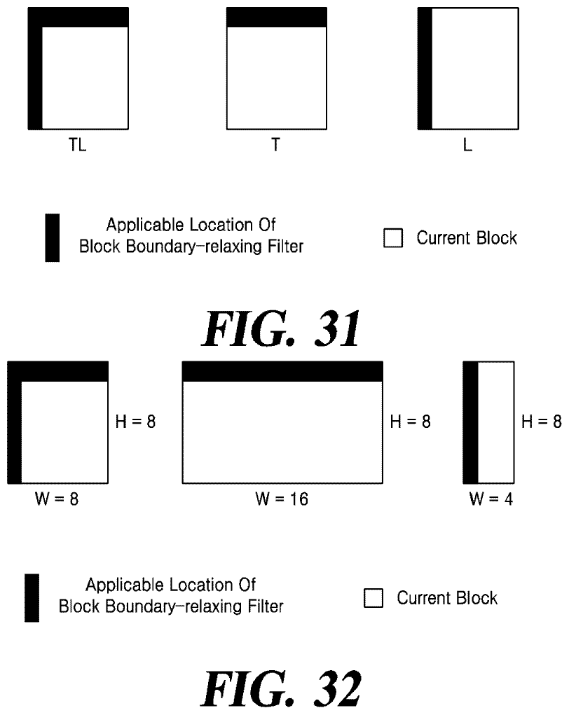

In this implementation, the video decoding device may infer or be signaled where to apply the block boundary discontinuity-relaxing filter. As shown in the example of FIG. 31, the block boundary discontinuity-relaxing filter may be applied to both the top and left boundaries at TL of the current block, the top boundary at T, or the left boundary at L. The filter application location may be determined by any of the following methods.

First, the video decoding device may utilize one of the three preset locations of TL, T, and L as the filter application location.

Second, the video decoding device may determine the filter application location by considering the aspect ratio of the current block. As shown in the example of FIG. 32, where the block's width W and height H are the same, the filter is applied to both the top and left boundaries of the block. Where the block's width is greater than the height, a filter is applied to the block's top boundary, and where the block's height is greater than the width, a filter is applied to the block's left boundary. The filter application location may be determined by the aspect ratio in other configurations than the above.

Third, the video decoding device may be signaled where to apply the filter. For example, at the CU level, the video decoding device may parse boundary_filter_position_idx as shown in Table 1 to determine the filter application location.

TABLE 1

| boundary_filter_position_idx | Filter Position |
|---|---|
| 0 | TL |
| 1 | T |
| 2 | L |

### Implementation 1-2-3: Determining the Size of a Region Subject to Block Boundary Discontinuity-Relaxing Filter

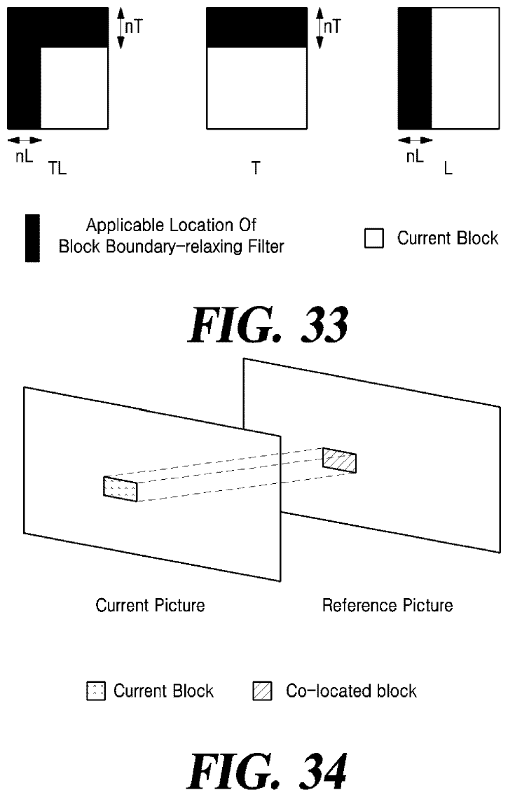

In this implementation, the video decoding device infers or is signaled the size of the region to apply the block boundary discontinuity-relaxing filter. The size of the region subject to the block boundary discontinuity-relaxing filter represents the number of pixels from the block boundary to which the filter is applied, as shown in the example of FIG. 33. Here, nT is the number of pixels in the block from the top boundary of the block, representing the size of the coverage area of the filter when applied to the top boundary of the block. Then, nL is the number of pixels in the block from the left boundary of the block, representing the size of the coverage area of the filter when applied to the left boundary of the block. Both nT and nL may have a value of 1 or more. The size of the coverage area of the block boundary discontinuity-relaxing filter may be determined according to any of the following methods.

First, the video decoding device may use a preset nT and a preset nL to determine the size of the application region. For example, if the filter is determined to be applied only to the top boundary of the current block, and both the preset nT and nL are 3, the video decoding device may apply the block boundary discontinuity-relaxing filter to three pixels adjacent to the top boundary of the current block.

Second, the video decoding device may determine the size of the region subject to the block boundary discontinuity-relaxing filter by considering the width and height of the current block. Using a preset positive integer k, nT and nL may be determined in proportion to the width and height of the current block, as shown in Equation 15.

$$nT = round ( \frac{Height of Current Block}{k} ) , \qquad Equation 15$$

$$nL = round ( \frac{Width of Current Block}{k} )$$

Here, k may be a positive integer that is less than or equal to the width and height of the current block. Taking into account the computational complexity of the division process in hardware implementations, k may be limited to a value in the form of a power of two.

Third, the video decoding device may use nT and nL after being signaled, respectively, which represent the size of the region subject to the block boundary discontinuity-relaxing filter.

Implementation 2: Utilizing Other Picture's Co-Located Pixels with the Current Block

In this implementation, to remove discontinuities between the current block and neighboring pixels, the video decoding device utilizes the co-located pixels with the current block, which are in another picture temporally adjacent to the current picture. Specifically, as shown in the example of FIG. 34, the video decoding device may weighted-sum a predictor of the current block and another picture's co-located block with the current block.

This implementation may be performed by Implementation 1-1 with the additional predictor replaced by a co-located block. The resulting weighted summation is expressed as in Equation 16.

$$Equation 16$$

$$pred ( i , j ) = w ( i , j ) \times {pred}_{inter} ( i , j ) + ( 1 - w ( i , j ) ) \times {area}_{co - located block} ( i , j )$$

Here, (i) denotes the location of the pixel. ‘pred’ denotes the final predictor of the current block, ‘predᵢₙₜₑᵣ’ denotes the inter-predictor, and ‘area_{co-located block}’ denotes the region corresponding to the co-located block. With increasing number of reference pictures, another area_{co-located block} may be added to Equation 16, and the weights may also be distributed for each of the co-located blocks within (1−w(i,j)).

Hereinafter, the inter-predictor is used interchangeably with the first predictor, and the co-located block is used interchangeably with the second predictor.

This implementation may be performed according to (Implementation 2-1) a method of selecting reference pictures holding the co-located block, and (Implementation 2-2) a method of weighted summing the current block's predictor and the co-located block.

### <Implementation 2-1> Selecting Reference Pictures Holding the Co-Located Block

In this implementation, the video decoding device infers or is signaled reference pictures to obtain the co-located block to be used for weighted summation. When a plurality of co-located blocks are used for weighted summation, one method of inferring or getting signaled may select a plurality of reference pictures or a combination of both methods may be used to select the reference pictures. The reference pictures may be selected according to any of the following methods.

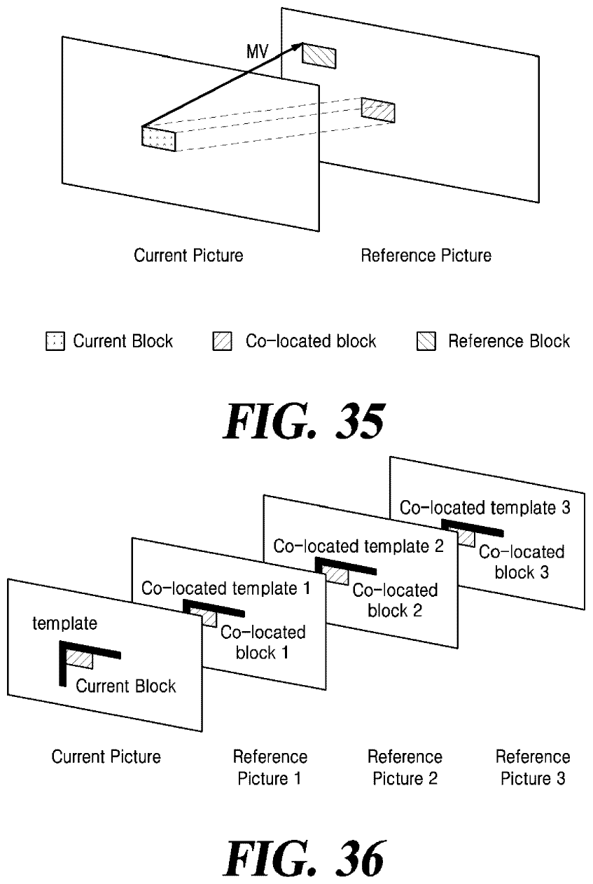

First, the video decoding device may use, as the reference picture holding the co-located block, the same picture holding the same reference block as used when the predictor of the current block is generated. In this case, if MV is (0, 0), the reference block is the same as the co-located block, so this method cannot be applied. Therefore, the case where MV is (0, 0) is excluded. For example, when MV is (−30,−40), the video decoding device searches for a co-located block in the reference picture holding the reference block as shown in the example of FIG. 35 and uses the searched co-located block for the weighted summation.

Where uni-directional prediction generates a predictor of the current block, i.e., when a single reference picture is used, one co-located block may be selected according to the method described above. Where bi-directional prediction is performed, i.e., when a plurality of reference pictures are used, a plurality of co-located blocks may be selected and may be used in a plurality of weighted summations. Additionally, one block may be selected from the plurality of co-located blocks and may be used in the weighted summation. In this case, a method of signaling an index indicating the plurality of co-located blocks may be used, or a method of selecting a block that is most similar to the current block may be used.

Second, the video decoding device may search for a picture having a co-located template that is most similar to the template of the current block, and may infer the searched picture as a reference picture. As shown in the example in FIG. 36, the template represents a neighbor region over the top and left boundaries of the block. To determine the similarity between templates, a sum of absolute difference (SAD), mean square error (MSE), structural similarity (SSIM), peak signal-to-noise ratio (PSNR), or the like may be utilized. The video decoding device searches for a reference picture from a preset number of pictures that have been decoded before the current picture.

For example, when three pictures are referenced, as in the example of FIG. 36, the video decoding device performs a search for three co-located templates. The video decoding device may search the co-located template that is most similar to the template of the current block, and then may use the co-located block of the picture containing that co-located template in the weighted summation.

Third, the video decoding device may receive a signal of the co-located block. The video decoding device may determine a picture containing the co-located block by receiving a reference picture index transmitted. The video decoding device may then use the co-located block in that picture in the weighted summation.

### Implementation 2-2: Weighted Summation of the Current Block's Predictor and the Co-Located Block

This implementation relates to a method of weighted summing the current block's inter-predictor and the co-located block. This implementation may be performed in the same way as (Implementation 1-1-2-1) the method of using predefined weights, (Implementation 1-1-2-4) the method of setting weights based on the location of pixels in the current block, and (Implementation 1-1-2-5) the method of signaling weights.

### Implementation 3: Signaling Implementations 1 and 2

In this implementation, the video decoding device may be further signaled to selectively apply the methods of Implementations 1 and 2 above, depending on the implementation. To do so, the video encoding device may transmit a boundary_reduction_flag to indicate information about how to reduce block boundary discontinuities when a predictor of the current block is generated. For example, the video decoding device may not apply the present disclosure if the boundary_reduction_flag is 0, and may apply Implementation 2 if the boundary_reduction_flag is 1, as shown in Table 2.

TABLE 2

| | | |
|---|---|---|
| boundary_reduction_flag | 0 | Keep existing method |
| | 1 | Remove block boundary discontinuities |
| | | by Implementation 2 |

Alternatively, the video decoding device may be further signaled with boundary_reduction_idx if the boundary_reduction_flag is 1, and select one of the methods of Implementations 1-1, 1-2, or 2 to use, as shown in Table 3.

TABLE 3

| boundary_reduction_flag | 0 | Keep existing method | | |
|---|---|---|---|---|
| | 1 | boundary_reduction_idx | 0 | Remove block boundary |
| | | | | discontinuities by |
| | | | | Implementation 1-1 |
| | | | 1 | Remove block boundary |
| | | | | discontinuities by |
| | | | | Implementation 1-2 |
| | | | 2 | Remove block boundary |
| | | | | discontinuities by |
| | | | | Implementation 2 |

### III. Implementations in the Case of IBC

If the prediction mode of the current block is IBC, this implementation may be performed identically to the implementations of inter prediction described above. However, all those indicated by MV are replaced with BV used for IBC prediction.

In addition, among the methods of selecting a reference picture holding the co-located block in Implementation 2, ‘using the same picture as the picture in which the reference block exists as a reference picture’ is not applicable when the prediction technique is IBC, so the implementation is excluded.

### IV. Implementations in the Case of CCLM

If the predicted mode of the current chroma block is CCLM, this implementation may be performed by modifying the above implementations of inter prediction to reflect the characteristics of CCLM used for the prediction of the chroma block.

### <Implementation 4> Using Adjacent Pixels of the Current Chroma Block in the Current Picture

In this implementation, the video decoding device utilizes pixels adjacent to the current chroma block in the current picture to remove discontinuities between the current chroma block and neighboring pixels. This may be accomplished by (Implementation 4-1) weighted summation of the CCLM predictor and an additional predictor, or by (Implementation 4-2) applying a filter at the expected location of the discontinuity. Here, the CCLM predictor represents the predictor of the current chroma block generated based on a linear relation between the channels. The CCLM mode may determine the location of the luma pixels used to generate the linear relation.

### Implementation 4-1: Weighted Summation of CCLM Predictor and Additional Predictors

In this implementation, the video decoding device generates a final predictor of the current chroma block by weighted summation of the CCLM predictor and the additional predictor to remove block boundary discontinuities. The additional predictor may be generated by performing an intra prediction on the current chroma block by using adjacent pixels. The weighted summation may be expressed as Equation 17.

$$Equation 17$$

$$pred ( i , j ) = w ( i , j ) \times {pred}_{CCLM} ( i , j ) + ( 1 - w ( i , j ) ) \times {pred}_{add} ( i , j )$$

Here, (i,j) represents the location of a pixel. ‘pred’ denotes the final predictor for the current chroma block, ‘pred_{CCLM}’ denotes the CCLM predictor that is based on a linear relation between channels, and ‘pred_{add}’ denotes an additional predictor according to this implementation. If multiple additional predictors are used, additional predictors besides ‘pred_{add}’ may be added to Equation 17 and the weights may also be distributed among the additional predictors within (1−w(i,j)).

Hereinafter, the CCLM predictor is used interchangeably with the first predictor and the additional predictors are used interchangeably with the second predictor.

This implementation may vary according to (Implementation 4-1-1) a method of generating additional predictors according to the intra prediction based on adjacent pixels and (Implementation 4-1-2) a weighted summing method.

### Implementation 4-1-1: Generating Additional Predictors According to Intra-Predictions Based on Adjacent Pixels

In this implementation, to perform an intra prediction based on adjacent pixels, the video decoding device autonomously infers a method of generating additional predictors or is signaled with information on the method of generating additional predictors. For this purpose, this implementation may use (Implementation 4-1-1-1) a method of inferring or signaling an intra-prediction mode, (Implementation 4-1-1-2) a new intra-prediction method, or (Implementation 4-1-1-3) a combined method of Implementation 4-1-1-1 and Implementation 4-1-1-2 to generate a plurality of additional predictors.

### Implementation 4-1-1-1: Inferring or Signaling Intra-Prediction Mode

In this implementation, the video decoding device derives the intra-prediction mode by using information on adjacent blocks of the current chroma block in the current channel, and/or information on blocks in the corresponding region of the other channel. Alternatively, the video decoding device uses a predefined or signaled intra-prediction mode. In this case, the current channel represents a chroma channel, and the other channel may be a luma channel or another chroma channel. Hereinafter, ‘corresponding region of the other channel’ refers to a region that is present in the other channel and corresponds to the current chroma block.

In generating the additional predictor, the intra-prediction mode of the conventional VVC may be used as it is without adding complex techniques. For example, the video decoding device sets the prediction mode of the additional predictor to one of the existing intra-prediction modes. At this time, the set prediction mode is expressed as a representative mode which may be determined as follows.

First, the video decoding device may use a predefined prediction mode as the representative mode. In this case, the prediction mode that can be used may be a mode that generates predictors based on neighboring pixels, such as 67 IPMs, MIP mode, or the like. For example, if the prediction mode of a single additional predictor is defined as planar mode, Equation 2, which represents the final predictor of the current chroma block, may be expressed as Equation 18.

$$pred ( i , j ) = w ( i , j ) \times {pred}_{CCLM} + ( 1 - w ( i , j ) ) \times {pred}_{planar} \qquad Equation 18$$

Second, the video decoding device may infer the representative mode from information on neighboring blocks adjacent to the current chroma block in the current channel.

As one example, the video decoding device may use as the representative mode the intra-prediction mode of a block containing pixels at a specific location among the neighboring pixels of the current chroma block. In this case, one or more of the locations 1 to 5 illustrated in FIG. 8, and any additional locations, may be selected as the specific location.

For example, the current chroma block's neighboring blocks and prediction modes are assumed to be distributed as shown in the example of FIG. 9. The numbers in the blocks shown indicate the prediction modes. When a representative mode is derived based on the neighboring pixel located at the top left (location 1 in the example of FIG. 8), the video decoding device uses mode 18 as the representative mode.

In the examples of FIGS. 8 and 9, the current block may be the current chroma block.

As another example, the video decoding device may derive the most frequent prediction mode based on the block count among the intra-prediction modes of the neighboring blocks adjacent to the current chroma block and may use the most frequent prediction mode as the representative mode. For example, in the example of FIG. 10, if there are five adjacent blocks and three of the blocks use the planar mode, the video decoding device uses the planar mode as the representative mode.

If there are more than two most frequent prediction modes, more than two most frequent prediction modes may be prioritized separately to derive the representative mode. In this case, a preset priority may be used, such as {planar, DC, horizontal mode, vertical mode, . . . }, in ascending or descending order. Alternatively, blocks in the relevant mode may be given a higher priority the closer the blocks are to the top left. For example, in the example of FIG. 11, if a higher priority is given to a block closer to the top left, the block in mode 18 has a higher priority since the block in mode 18 is closer to the top left than the block in planar mode. Therefore, the video decoding device derives the representative mode with mode 18. In addition to this, if there are more than two most frequent prediction modes, the representative mode may be derived based on a predefined rule.

In the examples of FIGS. 10 and 11, the current block may be the current chroma block.

As yet another example, the video decoding device may derive the most frequent prediction mode based on block area among intra-prediction modes of adjacent blocks of the current block and may use the most frequent prediction mode as a representative mode. In this implementation, the video decoding device may use the block area in place of the number of blocks when the most frequent prediction mode is derived.

As yet another example, the video decoding device may derive the most frequent prediction mode based on the intra-prediction mode of the block containing each neighboring pixel of the current chroma block and may use the most frequent prediction mode as a representative mode. In addition to pixels simply adjacent to the current chroma block, also considered may be pixels on a neighboring pixel line somewhat distanced from the current chroma block, as in the example of FIG. 12. The video decoding device may select only one of the plurality of neighboring pixel lines, select two or more neighboring pixel lines, or utilize such various combinations. Furthermore, when the predictor is generated with intra prediction, if the generation of neighboring pixels happens to use a method such as padding for no necessary neighboring pixels being present, the video decoding device may take into account only the originally present neighboring pixels, excluding the padded neighboring pixels.

For example, a case is assumed where only a neighboring pixel line is used immediately adjacent to the current chroma block. In the example of FIG. 13, of the 17 neighboring pixels, including the 16 neighboring pixels adjacent to the left and top of the current block and the one neighboring pixel at the top left, there is the largest number of 8 pixels that use the planar mode. Therefore, the video decoding device uses the planar mode as a representative mode.

In the examples of FIGS. 12 and 13, the current block may be the current chroma block.

As yet another example, the video decoding device may use as the representative mode the intra-prediction mode of the neighboring blocks of the current chroma block that have the same (or most similar) aspect ratio as the current block. For example, when the current chroma block's neighboring blocks and prediction modes are distributed as shown in the example in FIG. 14, the prediction modes of blocks with the same aspect ratio as the current chroma block are planar mode and DC mode. If multiple prediction modes were derived, the prediction mode of the block with the largest size may be used as the representative mode. Therefore, the video decoding device uses the planar mode as the representative mode in this example.

In the example of FIG. 14, the current block may be the current chroma block.

Third, the video decoding device may infer the representative mode from information on a block contained in the corresponding region of the other channel. As described above, the other channel for use may be a luma channel or another chroma channel. The corresponding region indicates a region that is in the other channel and is co-located with the current chroma block.

In one example, the video decoding device may use as a representative mode the intra-prediction mode of a block containing pixels at a specific location within the corresponding region of the other channel. In this case, one or more of the various locations within the corresponding region may be designated as the specific location, as shown in the example of FIG. 15.

For example, with the blocks and prediction modes distributed in the corresponding regions of the other channel as shown in the example of FIG. 16, a representative mode may be derived based on the pixel located at the bottom left (location 7 in the example of FIG. 15). In this case, the video decoding device uses the planar mode as the representative mode.

In the example of FIGS. 15 and 16, the MV-indicated region may be the corresponding region of the other channel.

As another example, the video decoding device may use as the representative mode the most frequent intra-prediction mode based on the block count among the intra-prediction modes of the blocks in the corresponding region of the other channel.

With the blocks and prediction modes distributed in the corresponding region of the other channel as shown in the example of FIG. 17, there are a total of five blocks, two of which utilize the planar mode. Therefore, the video decoding device utilizes the planar mode as a representative mode.

If there are more than two most frequent prediction modes, a representative mode may be derived by prioritizing them separately. A preset priority may be used, such as {planar, DC, horizontal mode, vertical mode, . . . }, in ascending or descending order. Alternatively, blocks in a given mode may be given a higher priority as the blocks occupy a larger area within the corresponding region. For example, in the example of FIG. 18, where a block in a corresponding mode is given a higher priority as the block occupies a larger area within the corresponding region, the block in mode 22 has a higher priority because the block in mode 22 occupies a larger area within the corresponding region than the block in DC mode. Therefore, the video decoding device derives the representative mode as mode 22. Besides, if there are more than two most frequent prediction modes, the representative mode may be derived based on a predefined rule.

In the examples of FIGS. 17 and 18, the MV-indicated region may be the corresponding region of the other channel.

As another example, the video decoding device may derive the most frequent prediction mode based on the block area among the intra-prediction modes of the blocks in the corresponding region of the other channel and may use the most frequent prediction mode as the representative mode. In this implementation, when the most frequent prediction mode is derived, the video decoding device uses the block area in place of the number of blocks.

As another example, the video decoding device may use as the representative mode the intra-prediction mode of blocks in the corresponding region of the other channel that has the same aspect ratio as (or most similar to) the current chroma block. For example, with the blocks and prediction modes distributed in the corresponding region of the other channel as shown in the example of FIG. 19, the prediction modes of the blocks having the same aspect ratio as the current chroma block are planar mode and mode 22. If multiple prediction modes were derived, the prediction mode of the block with the largest size may be used as a representative mode. Therefore, the video decoding device uses the planar mode as the representative mode in this example.

On the other hand, in the example of FIG. 19, the MV-indicated region may be the corresponding region of the other channel.

Fourth, the video decoding device may infer the representative mode from information on the neighboring block in the corresponding region of the other channel. This method is equivalent to the method of ‘inferring the representative mode from information on the neighboring block of the current chroma block in the current channel’ with the current chroma block replaced by ‘the corresponding region of the other channel’.

Fifth, the video decoding device does not infer a representative mode for use in generating additional predictors, but instead uses the parsed representative mode after being signaled thereof from the video encoding device.

### Implementation 4-1-1-2: Using a New Intra-Prediction Method

In this implementation, the video decoding device generates additional predictors by using a deep learning-based neural network. The predictor generation method used is different from the existing intra-prediction method.

For example, the video decoding device may generate the additional predictors by using a neural network with neighboring pixels of the current chroma block as input. In this case, the neural network is pre-trained to generate the additional predictors. Further, a single neural network may be used steadily, or one neural network of the plurality of neural networks may be used after the one is determined based on the signal.

### Implementation 4-1-1-3: Implementation 4-1-1-1 and Implementation 4-1-1-2 Combined

In this implementation, the video decoding device may combine the methods of Implementation 4-1-1-1 and Implementation 4-1-1-2 to generate a plurality of predictors based on neighboring pixels of the current chroma block. If there are two additional predictors, two additional predictors may be weighted and summed as shown in Equation 19.

$$Equation 19$$

$$pred ( i , j ) = w ( i , j ) \times {pred}_{CCLM} ( i , j ) + ( 1 - w ( i , j ) ) \times \{ {w}_{1} \times {pred}_{add 1} + {w}_{2} \times {pred}_{add 2} \}$$

Here, w₁+w₂=1.

To generate the additional predictors, the video decoding device may use any of the methods described above, or may use different methods for each predictor to generate a plurality of predictors. For example, when two additional predictors, the planar mode which is a predefined conventional intra-prediction technique and VER (No. 50) mode which is a prediction mode inferred from information on the neighboring block of the current chroma block in the current channel are used, the final predictor for the current chroma block is represented by Equation 20.

$$Equation 20$$

$$pred ( i , j ) = w ( i , j ) \times {pred}_{CCLM} + ( 1 - w ( i , j ) ) \times \{ {w}_{1} \times {pred}_{planar} + {w}_{2} \times {pred}_{VER} \}$$

The present disclosure envisions many other combinations, and as the number of additional predictors grows, more combinations of additional predictor generation methods may be provided.

### Implementation 4-1-2: Weighted Summation of CCLM Predictor and Additional Predictors

This implementation relates to a method for weighted summation of the CCLM predictor of the current chroma block and additional predictors. The video decoding device applies the weight setting method of each predictor to the case where there is one additional predictor in addition to the CCLM predictor by default, but the same method may be applied to the case where there are multiple additional predictors. Among the following weighted summing methods, Implementations 4-1-2-1 through 4-1-2-3 set equal weights for pixels within a predictor, and thus Implementations 4-1-2-1 through 4-1-2-3 use Equation 21 which excludes the influence of pixel coordinates (i,j) within a predictor.

$$pred = w \times {pred}_{CCLM} + ( 1 - w ) \times {pred}_{add} \qquad Equation 21$$

Additionally, Implementation 4-1-2-4 sets different weights based on pixel coordinates (i,j) within the predictor, so Implementation 4-1-2-4 uses Equation 17 as it is.

### Implementation 4-1-2-1: Using Pre-Defined Weights

In this implementation, the video decoding device uses a predefined weight w. In this case, an even weight may be used or a high weight (e.g., 3:1, 7:1, and the like) may be used for the CCLM predictor of the current chroma block.

For example, equal weights may be set for all predictors, as shown in Equation 22.

$$pred = \frac{1}{2} \times {pred}_{CCLM} + \frac{1}{2} \times {pred}_{add} ( w = \frac{1}{2} ) \qquad Equation 22$$

Alternatively, a high weight may be set for a predictor generated according to the current chroma block's prediction method, CCLM prediction, as shown in Equation 23.

$$pred = \frac{3}{4} \times {pred}_{CCLM} + \frac{1}{4} \times {pred}_{add} ( w = \frac{3}{4} ) \qquad Equation 23$$

Implementation 4-1-2-2: Deriving Weights from Information on Neighboring Blocks of the Current Chroma Block

In this implementation, the video decoding device derives a weight w from information on neighboring blocks of the current chroma block. The weight w may be derived according to any of the following methods.

First, the video decoding device derives the proportion of the current block's adjacent blocks that use the representative mode based on the block count to derive the weight w as shown in Equation 24.

$$w = 1 - \frac{Number of Blocks Using Representative Mode}{Total Number of Adjacent Blocks} \qquad Equation 24$$

Here, w represents the weight of the CCLM predictor of the current chroma block.

For example, when the current chroma block's adjacent blocks and prediction modes are distributed as shown in the example of FIG. 22, there are a total of 5 adjacent blocks, of which 3 is the number of adjacent blocks that use the planar mode which is a representative mode. Therefore, the video decoding device may set 3/5 as the weight of the additional predictor and may set 2/5 as the weight of the CCLM predictor.

Second, the video decoding device derives the proportion of adjacent blocks of the current chroma block that use the representative mode based on the block area to derive a weight w, as shown in Equation 25.

$$w = 1 - \frac{Area of Blocks Using Representative Mode}{Total Number of Adjacent Blocks} \qquad Equation 25$$

Here, w represents the weight of the CCLM predictor of the current chroma block.

For example, when the current chroma block's adjacent blocks and prediction modes are distributed as shown in the example of FIG. 23, the total area of the adjacent blocks is 272, of which 112 is the area of the adjacent blocks using the representative mode, planar mode. Therefore, the video decoding device may set 112/272 as the weight of the additional predictor and may set 160/272 as the weight of the CCLM predictor.

Third, the video decoding device derives the proportion of the current chroma block's adjacent blocks that use the representative mode based on the lengths of contacting sides between the current chroma block and the adjacent blocks to derive a weight w as shown in Equation 26.

$$Equation 26$$

$$w = 1 - \frac{Length of Side Adjacent to Blocks Using Representative Mode}{Total Length of Side Adjacent to Current Block}$$

Here, w represents the weight of the CCLM predictor of the current chroma block.

For example, when the current chroma block's adjacent blocks and prediction modes are distributed as shown in the example of FIG. 24, the total length of contacting sides between the current chroma block and its adjacent blocks is 32, 16 of which is the length of the contacting sides between the current chroma block and its adjacent blocks using the representative mode of planar mode. Accordingly, the video decoding device may set 16/32 as the weight for the additional predictors and may set 16/32 as the weight for the CCLM predictor.

Further, in connection with the foregoing methods, in the examples of FIGS. 22 through 24, the current block may be the current chroma block.

Further, when a plurality of predictors are weighted summed in the above methods, the video decoding device may calculate the weight of each additional predictor in the same way, and may set the value generated by subtracting from 1 the sum of the weights for the additional predictors as the weight of the CCLM predictor.

On the other hand, in the above methods, if the number of total adjacent blocks, the area of total adjacent blocks, or the length of the sides of total adjacent blocks is not in the form of a power of two, the hardware implementation may encounter significantly increased computational complexity of the division process. To avoid the increased complexity, the weights may be approximated to the powers of two for each denominator and numerator during the weighted summing process by using an operation such as Equation 27, and then the weights may be derived.

$$Equation 27$$

$$Number of Adjacent blocks Approximated = ( Number of Adjacent Blocks ) ≪ 1$$

$$Area of Adjacent blocks Approximated = ( Area of Adjacent Blocks ) ≪ 1$$

<Implementation 4-1-2-3> Deriving Weights from Information on the Blocks in the Corresponding Region of the Other Channel

In this implementation, the video decoding device derives a weight w from information on the blocks contained in the corresponding region of the other channel. The weights may be derived according to any of the following methods.

First, the video decoding device derives the proportion of blocks that use the representative mode among the blocks included in the corresponding region of the other channel, based on the block count, to derive the weight w as shown in Equation 28.

$$Equation 28$$

$$w = 1 - \frac{Number of Blocks Using Representative Mode}{\begin{matrix}Total Number of Blocks in Corresponding Region in \\ Another Channel\end{matrix}}$$

Here, w represents the weight of the CCLM predictor of the current chroma block.

For example, with the blocks and prediction modes distributed in the corresponding regions of the other channel as shown in the example of FIG. 25, the total number of blocks included in the corresponding regions of the other channel is 5, 2 of which is the number of blocks using the representative mode, planar mode. Therefore, the video decoding device may set 2/5 as the weight of the additional predictor and may set 3/5 as the weight of the CCLM predictor.

Second, the video decoding device derives, based on the block area, the proportion of the blocks that use the representative mode among blocks in the corresponding region of the other channel to derive a weight w, as shown in Equation 29.

$$w = 1 - \frac{Overlapping Area with Representative Mode Blocks}{Area of Corresponding Region in Another Channel} \qquad Equation 29$$

Here, w represents the weight of the CCLM predictor of the current chroma block.

For example, with the blocks and predictor modes distributed in the corresponding region of the other channel as shown in the example of FIG. 26, the total area of the corresponding region of the other channel is 256, 96 of which is the area overlapped with the corresponding region by the blocks using the representative mode planar mode. Therefore, the video decoding device may set 96/256 as the weight of the additional predictor and may set 160/256 as the weight of the CCLM predictor.

In connection with the foregoing methods, the area indicated by the MV in the examples of FIGS. 25 to 26 may be the corresponding area of the other channel.

Further, when performing the weighted summation of a plurality of predictors in the above methods, the video decoding device may calculate the weight for each additional predictor in the same way, and set the value generated by subtracting from 1 the sum of the weights for the additional predictors as the weight of the CCLM predictor.

On the other hand, in the above methods, if the number of total blocks or the area of total blocks is not in the form of a power of two, the hardware implementation may encounter significantly increased computational complexity of the division process. To avoid this increased complexity, the weights may be approximated to the powers of two for each denominator and numerator by using an operation such as Equation 27, and then the weights may be derived.

### Implementation 4-1-2-4: Setting Weights According to the Location of the Pixel in the Current Chroma Block

In this implementation, the weights are set for each pixel within the predictor, as opposed to the previous three implementations where the same weights are set for the entire predictor. To set weights per pixel, separate weights may be set for each pixel, but it may be more effective to group pixels and then set weights for each group.

Thus, in this implementation, the video decoding device groups the pixels in the predictor and sets a weight for each group. The pixels in the predictor may be grouped according to various grouping methods, as illustrated in FIG. 27. In the example in FIG. 27, four groups are used for each method, but the number of groups may vary depending on the size, shape, and the like of the block. The grouping method may be inferred or signaled. First, the inferring of a grouping method is as follows.

The video decoding device may steadily use one of the grouping methods of \textcircled{a}-\textcircled{h} in FIG. 27 to group the pixels or may determine the grouping method based on a representative mode. For example, grouping methods such as \textcircled{a}, \textcircled{e}, and \textcircled{g} in FIG. 27 may be used for prediction modes that use both top neighboring pixels and left neighboring pixels (e.g., planar mode, DC mode, and prediction modes between 19 and 49). Further, grouping methods such as \textcircled{b}, \textcircled{c}, and \textcircled{f} in FIG. 27 may be used for prediction modes that use only the left neighboring pixels (e.g., prediction modes 18 and below, DC mode, and the like). Additionally, grouping methods such as \textcircled{b}, \textcircled{c}, and \textcircled{h} in FIG. 30 may be used for prediction modes that use only the top neighboring pixels (e.g., prediction modes 50 and above, DC mode, and the like).

The video decoding device may set weights for each group of pixels by considering their distance from neighboring pixels. For example, the weights for the CCLM predictor may be set to be larger the farther away from the neighboring pixels, and the weights for the additional predictors generated according to the representative mode may be set to be smaller the farther away from the neighboring pixels. When the pixels are grouped by the method of \textcircled{e} in FIG. 27, the weights for the CCLM predictor and the additional predictor may be set as shown in the example of FIG. 28. In this case, the predictor pred(0,0) for location (0,0) of the current chroma block may be calculated as shown in Equation 30.

$$pred ( 0 , 0 ) = ( \frac{1}{4} {pred}_{CCLM} ( 0 , 0 ) + \frac{3}{4} {pred}_{add} ( 0 , 0 ) ) \qquad Equation 30$$

The examples of FIG. 27 illustrate grouping methods for when the current chroma block is square. If the current chroma block is rectangular, the grouping methods illustrated in FIG. 27 may be modified and used for a rectangular block. For example, the example of FIG. 29 illustrates grouping methods for a rectangular block with a height greater than a width, and the example of FIG. 30 illustrates grouping methods for a rectangular block with a width greater than a height.

In the examples of FIGS. 27 through 30, the current block may be the current chroma block.

### Implementation 4-1-2-5: Signaling Weights

In this implementation, the video decoding device uses weights after being signaled about thereof as being related to either the method of setting the same weight for all pixels in a block to perform weighted-summation or the method of grouping pixels in a block and setting the weight for the grouped to perform weighted-summation. If the grouping method is used, the video decoding device first parses the grouping method and then parses the weights for each group.

### Implementation 4-2: Applying a Filter at the Expected Location of a Discontinuity Occurrence

In this implementation, the video decoding device applies a block boundary discontinuity-relaxing filter to remove discontinuities at the boundaries of the current chroma block and neighboring blocks. The block boundary may represent the boundary of both the current chroma block and the neighboring blocks, but in the following description, only the edge region of the current chroma block's predictor is referred to as the block boundary. When the filter is applied to any pixel located at the block boundary, the values of neighboring pixels outside the current chroma block are used in the calculation of the pixel values inside the current chroma block, so that the features of the neighboring pixels may be reflected in the current chroma block's predictor. For this purpose, the following describes (Implementation 4-2-1) determining the type of block boundary discontinuity-relaxing filter, (Implementation 4-2-2) determining the location for applying the block boundary discontinuity-relaxing filter, and (Implementation 4-2-3) determining the size of the region subject to the block boundary discontinuity-relaxing filter.

### Implementation 4-2-1: Determining the Type of Block Boundary Discontinuity-Relaxing Filter

In this implementation, the video decoding device determines the type of block boundary discontinuity-relaxing filter. The relaxing filter may be determined according to any of the following methods.

First, the video decoding device may apply a predefined filter to the boundary where the discontinuity occurs. In this case, the applicable filter may be an n-tap filter, a cubic filter, a gaussian filter, or the like. The coefficients of the filter may also be predefined. For example, when applying a 3-tap filter, the coefficients of the filter may be pre-set to [1 2 1].

Second, the type of filter applied to the boundary where the discontinuity occurs may be signaled. The video decoding device may determine the type of filter by parsing, on a block basis, an index indicating one of a plurality of filters, including an n-tap filter, a cubic filter, a Gaussian filter, and the like.

### Implementation 4-2-2: Determining the Location for Applying Block Boundary Discontinuity-Relaxing Filter

In this implementation, the video decoding device may infer or be signaled where to apply the block boundary discontinuity-relaxing filter. As shown in the example of FIG. 31, the block boundary discontinuity-relaxing filter may be applied to both the top and left boundaries at TL of the current chroma block, the top boundary at T, or the left boundary at L. The filter application location may be determined by any of the following methods.

First, the video decoding device may utilize one of the three preset locations of TL, T, and L as the filter application location.

Second, the video decoding device may determine the filter application location by considering the aspect ratio of the current chroma block. As shown in the example of FIG. 32, where the block's width W and height H are the same, the filter is applied to both the top and left boundaries of the block. Where the block's width is greater than the height, a filter is applied to the block's top boundary, and where the block's height is greater than the width, a filter is applied to the block's left boundary. The filter application location may be determined by the aspect ratio in other configurations than the above.

Third, the video decoding device may be signaled where to apply the filter. For example, at the CU level, the video decoding device may parse boundary_filter_position_idx as shown in Table 1 to determine the filter application location.

In connection with the foregoing methods, in the example of FIGS. 31 to 32, the current block may be the current chroma block.

### Implementation 4-2-3: Determining the Size of a Region Subject to the Block Boundary Discontinuity-Relaxing Filter

In this implementation, the video decoding device infers or is signaled the size of the region to apply the block boundary discontinuity-relaxing filter. The size of the region subject to the block boundary discontinuity-relaxing filter represents the number of pixels from the block boundary to which the filter is applied, as shown in the example of FIG. 33. Here, nT is the number of pixels in the block from the top boundary of the block, representing the size of the coverage area of the filter when applied to the top boundary of the block. Then, nL is the number of pixels in the block from the left boundary of the block, representing the size of the coverage area of the filter when applied to the left boundary of the block. Both nT and nL may have a value of 1 or more. The size of the coverage area of the block boundary discontinuity-relaxing filter may be determined according to any of the following methods.

First, the video decoding device may use a preset nT and a preset nL to determine the size of the application region. For example, if the filter is determined to be applied only to the top boundary of the current chroma block, and both the preset nT and nL are 3, the video decoding device may apply the block boundary discontinuity-relaxing filter to three pixels adjacent to the top boundary of the current chroma block.

Second, the video decoding device may determine the size of the region subject to the block boundary discontinuity-relaxing filter by considering the width and height of the current chroma block. Using a preset positive integer k, nT and nL may be determined in proportion to the width and height of the current chroma block, as shown in Equation 31.

$$nT = round ( \frac{Height of Current Chroma Block}{k} ) , \qquad Equation 31$$

$$nL = round ( \frac{Width of Current Chroma Block}{k} )$$

Here, k may be a positive integer that is less than or equal to the width and height of the current chroma block. Taking into account the computational complexity of the division process in hardware implementations, k may be limited to a value in the form of a power of two.

Third, the video decoding device may use nT and nL after being signaled, respectively, which represent the size of the region subject to the block boundary discontinuity-relaxing filter.

In connection with the foregoing methods, in the example of FIG. 33, the current block may be the current chroma block.

Implementation 5: Utilizing Other Picture's Co-Located Pixels with the Current Chroma Block

In this implementation, to remove discontinuities between the current chroma block and neighboring pixels, the video decoding device utilizes the co-located pixels with the current chroma block, which are in another picture temporally adjacent to the current chroma picture. Specifically, as shown in the example of FIG. 34, the video decoding device may calculate the weighted sum of a predictor of the current chroma block and another picture's co-located block with the current chroma block.

This implementation may be performed by Implementation 4-1 with the additional predictor replaced by a co-located block. The resulting weighted summation is expressed as in Equation 32.

$$Equation 32$$

$$pred ( i , j ) = w ( i , j ) \times {pred}_{CCLM} ( i , j ) + ( 1 - w ( i , j ) ) \times {area}_{co - located block} ( i , j )$$

Here, (i,j) denotes the location of the pixel. ‘pred’ denotes the final predictor of the current chroma block, ‘pred_{CCLM}’ denotes the CCLM predictor, and ‘area_{co-located block}’ denotes the region corresponding to the co-located block. With the increasing number of reference pictures, another area_{co-located block} may be added to Equation 32, and the weights may be distributed for each of the co-located blocks within (1−w(i,j)).

Hereinafter, the CCLM predictor is used interchangeably with the first predictor, and the co-located block is used interchangeably with the second predictor.

This implementation may be performed according to (Implementation 5-1) a method of selecting a reference picture holding the co-located block, and (Implementation 5-2) a method of weighted summing the current chroma block's predictors and the co-located blocks.

In the example of FIG. 34, the current block may be the current chroma block.

### Implementation 5-1: Selecting Reference Pictures Holding the Co-Located Block

In this implementation, the video decoding device infers or is signaled reference pictures to obtain the co-located block to be used for weighted summation. When a plurality of co-located blocks are used for weighted summation, one method of inferring or getting signaled may select a plurality of reference pictures or a combination of both methods may be used to select the reference pictures. The reference pictures may be selected according to any of the following methods.

First, the video decoding device may search for a picture having a co-located template that is most similar to the template of the current chroma block, and may infer the searched picture as a reference picture. As shown in the example in FIG. 36, the template represents a neighbor region over the top and left boundaries of the block. To determine the similarity between templates, SAD, MSE, SSIM, PSNR, or the like may be utilized. The video decoding device searches for a reference picture from a preset number of pictures that have been decoded before the current picture.

For example, when three pictures are referenced, as in the example of FIG. 36, the video decoding device performs a search for three co-located templates. The video decoding device may search for the co-located template that is most similar to the template of the current chroma block, and then may use the co-located blocks of the pictures containing that co-located template in the weighted summation.

Second, the video decoding device may receive a signal of the co-located block. The video decoding device may determine a picture containing the co-located block by receiving a reference picture index transmitted. The video decoding device may then use the co-located block in that picture in the weighted summation.

In the example of FIG. 36, the current block may be the current chroma block.

### Implementation 5-2: Weighted Summation of the Current Chroma Block's Predictor and the Co-Located Block

This embodiment relates to a method of weighted summing the current chroma block's predictor and the co-located block. This embodiment can be implemented equally well as (Implementation 4-1-2-1) the method of using predefined weights, (Implementation 4-1-2-4) the method of setting weights based on the location of the pixels in the current chroma block, and (Implementation 4-1-2-5) the method of signaling weights.

### Implementation 6: Signaling Implementations 4 and 5

In this implementation, the video decoding device may be further signaled to selectively apply the methods of Implementations 4 and 5 above, depending on the implementation. To do so, the video encoding device may transmit a boundary_reduction_flag to indicate information about how to reduce block boundary discontinuities when a predictor for the current chroma block is generated. For example, the video decoding device may not apply the present disclosure if the boundary_reduction_flag is 0, and may apply Implementation 5 if the boundary_reduction_flag is 1, as shown in Table 4.

TABLE 4

| | | |
|---|---|---|
| boundary_reduction_flag | 0 | Keep existing method |
| | 1 | Remove block boundary discontinuities |
| | | by Implementation 5 |

Alternatively, the video decoding device may be further signaled with boundary_reduction_idx if the boundary_reduction_flag is 1, and select one of the methods of Implementations 4-1, 4-2, or 5 to use, as shown in Table 5.

TABLE 5

| boundary_reduction_flag | 0 | Keep existing method | | |
|---|---|---|---|---|
| | 1 | boundary_reduction_idx | 0 | Remove block boundary |
| | | | | discontinuities by |
| | | | | Implementation 4-1 |
| | | | 1 | Remove block boundary |
| | | | | discontinuities by |
| | | | | Implementation 4-2 |
| | | | 2 | Remove block boundary |
| | | | | discontinuities by |
| | | | | Implementation 5 |

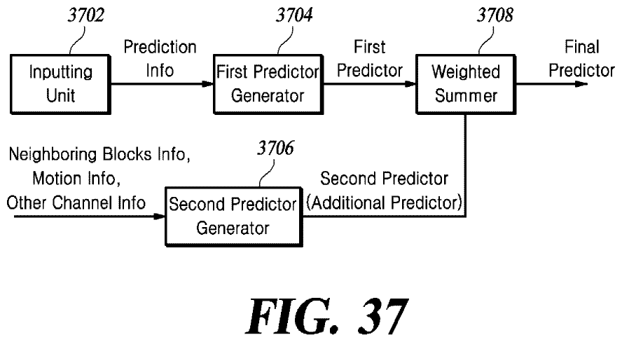

The following describes the operation of the predictor 540 in the video decoding device performing Implementations 1 through 6 with reference to FIG. 37.

FIG. 37 is a diagram illustrating a predictor performing a current block prediction, according to at least one embodiment of the present disclosure.

As described above, to reduce block boundary discontinuities, the predictor 540 in the video decoding device according to embodiments of the present disclosure generates a final predictor of the current block (or current chroma block) by weighted summing the first predictor and the second predictor. The predictor 540 according to the embodiments includes all or part of an inputting unit 3702, a first predictor generator 3704, a second predictor generator 3706, and a weighted summer 3708. The predictor 120 in the video encoding device may also include the same components. Here, the first predictor is an inter-predictor of the current block or a CCLM predictor of the current chroma block. If the first predictor is an inter-predictor, the second predictor is an additional predictor generated based on Implementations 1-1, 2, and 3, and if the first predictor is a CCLM predictor, the second predictor is an additional predictor generated based on Implementations 4-1, 5, and 6.

The inputting unit 3702 according to the embodiments obtains prediction information from the bitstream. If the first predictor is an inter-predictor, the inputting unit 3702 may obtain motion information of the current block as prediction information. Here, the motion information includes an index indicating a reference picture, and a motion vector. If the first predictor is a CCLM predictor, the inputting unit 3702 may obtain the CCLM mode of the current chroma block as the prediction information. Here, the CCLM mode determines the location of the luma pixels that are utilized to generate the linear relation between channels.

The first predictor generator 3704 may perform an inter prediction based on the motion information to generate a first predictor of the current block. Alternatively, the first predictor generator 3704 may perform a CCLM prediction based on the CCLM mode to generate a first predictor of the current chroma block.

The second predictor generator 3706 generates a second predictor. If the first predictor is an inter-predictor, the second predictor generator 3706 may use information on neighboring blocks and motion information to generate a second predictor of the current block. Here, the information on the neighboring blocks may include the width, height, aspect ratio, prediction mode, and the like of the neighboring blocks. Further, if the first predictor is a CCLM predictor, the video decoding device may generate a second predictor of the current chroma block by using the information on the neighboring blocks and information on the other channel. Here, the other channel may be a luma channel or another chroma channel. Further, the information on the other channel may include information related to a corresponding region of the other channel.

The weighted summer 3708 weighted-sums the first predictor and the second predictor by using weights to generate a final predictor of the current block (or current chroma block).

In this case, if the first predictor is an inter-predictor, the weighted summer 3708 may use the information on neighboring blocks and motion information to generate weights for the first predictor and the second predictor. Further, if the first predictor is a CCLM predictor, the video decoding device may generate the weights by using the information on neighboring blocks and the information on the other channel.

On the other hand, if the first predictor is an inter-predictor, the video decoding device may calculate the weighted sum of the first predictor and the second predictor by using weights as shown in Equation 1 or Equation 16. Further, if the first predictor is a CCLM predictor, the video decoding device may calculate the weighted sum of the first predictor and the second predictor by using weights as shown in Equation 17 or Equation 32.

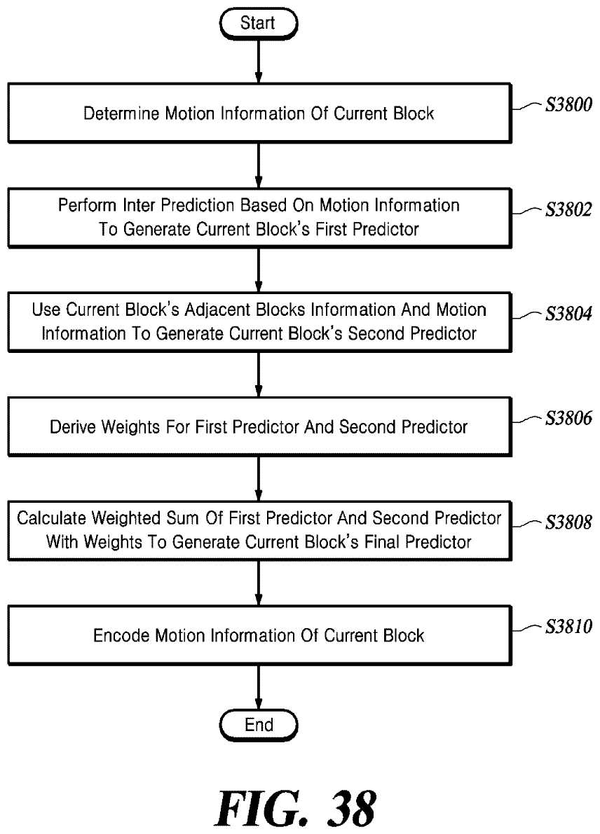

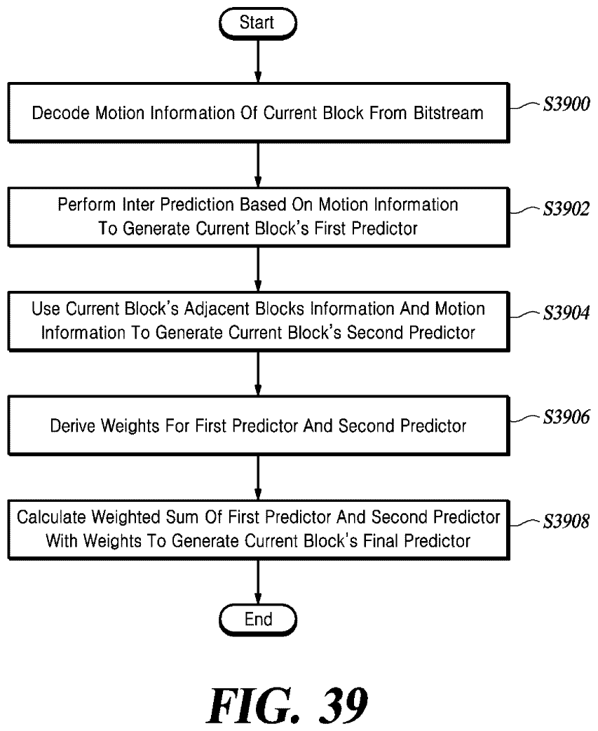

The following describes methods for the video encoding device or the video decoding device to generate a predictor for a current block (and current chroma block) with reference to FIGS. 38 and 39.

FIG. 38 is a flowchart of a method performed by the video encoding device for predicting the current block, according to at least one embodiment of the present disclosure.

The video encoding device determines the motion information of the current block (S3800). Here, the motion information includes an index of a reference picture and a motion vector of the current block. In terms of optimizing coding efficiency, the video encoding device may determine the motion information of the current block.

The video encoding device performs an inter prediction based on the motion information to generate a first predictor of the current block (S3802).

The video encoding device generates a second predictor of the current block by using information on the adjacent blocks of the current block and the motion information (S3804).

The video encoding device may generate the second predictor by inferring a representative mode by using the information on the adjacent blocks of the current block and motion information and then by performing an intra prediction that uses the neighboring pixels of the current block based on the representative mode. Here, the information on the adjacent blocks may include the width, height, aspect ratio, prediction mode, and the like of the neighboring blocks.

Alternatively, the video encoding device may generate the second predictor by inputting the adjacent pixels of the current block into a deep learning-based neural network.

Alternatively, the video encoding device may determine a reference picture holding the co-located block of the current block and may set the co-located block in the reference picture as the second predictor.

The video encoding device derives weights for the first predictor and the second predictor by using the information on the adjacent blocks of the current block and motion information (S3806).

The video encoding device uses the weights to calculate the weighted sum of the first predictor and the second predictor to generate a final predictor of the current block (S3808).

The video encoding device encodes the motion information of the current block (S3810).

FIG. 39 is a flowchart of a method performed by the video decoding device for predicting the current block, according to at least one embodiment of the present disclosure.

The video decoding device decodes the motion information of the current block from the bitstream (S3900). Here, the motion information includes an index of a reference picture and a motion vector of the current block.

The video decoding device performs inter prediction based on the motion information to generate a first predictor of the current block (S3902).

The video decoding device generates a second predictor of the current block by using the information on the adjacent blocks of the current block and the motion information (S3904).

The video decoding device may generate the second predictor by inferring a representative mode by using the information on the neighboring blocks of the current block and motion information and then by performing an intra prediction by using the neighboring pixels of the current block based on the representative mode. Here, the information on the adjacent blocks may include the width, height, aspect ratio, prediction mode, and the like of the neighboring blocks.

Alternatively, the video decoding device may generate the second predictor by inputting the adjacent pixels of the current block into a deep learning-based neural network.

Alternatively, the video decoding device may determine a reference picture holding the co-located block of the current block and may set the co-located block in the reference picture as the second predictor.

The video decoding device derives weights for the first predictor and the second predictor by using the information on the adjacent blocks of the current block and motion information (S3906).

The video decoding device weighted-sums the first predictor and the second predictor by using the weights to generate a final predictor of the current block (S3908).

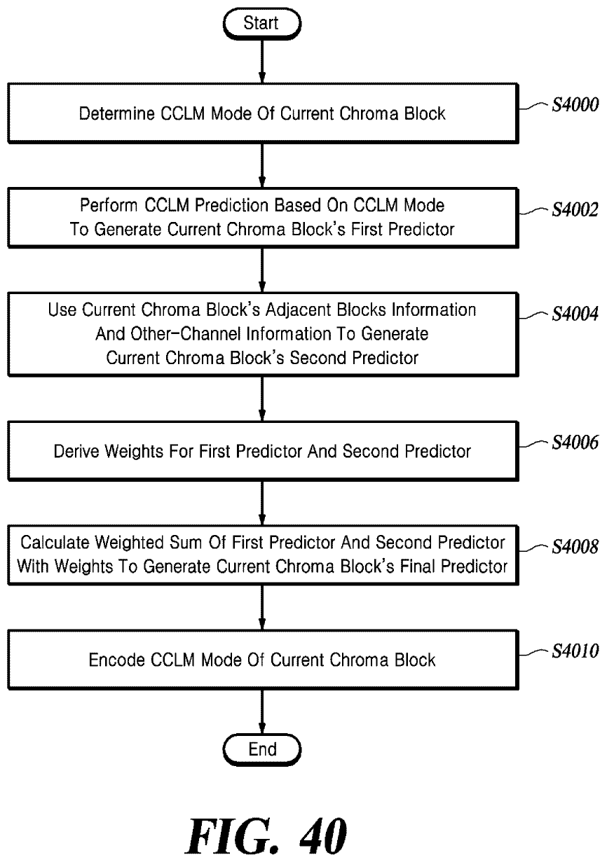

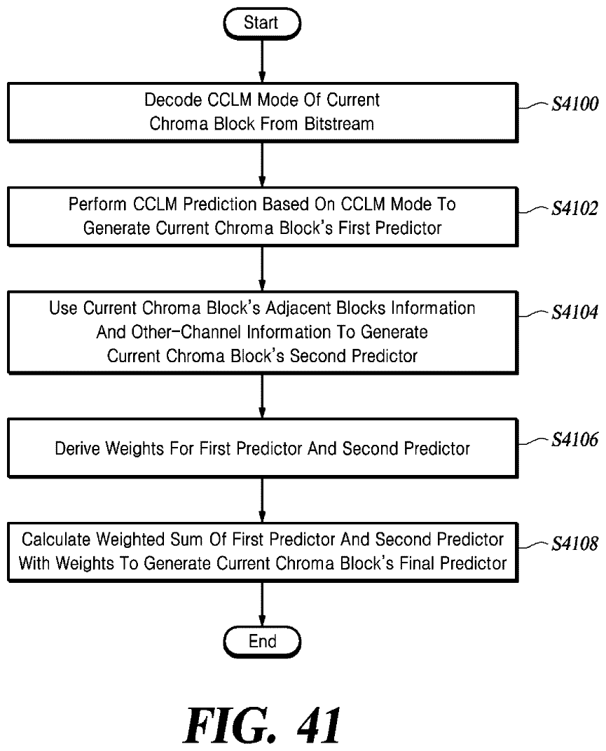

The following describes methods for the video encoding device or the video decoding device to generate a predictor of the current chroma block, with reference to FIGS. 40 and 41.

FIG. 40 is a flowchart of a method performed by the video encoding device for predicting a current chroma block, according to at least one embodiment of the present disclosure.

The video encoding device determines a CCLM mode of the current chroma block (S4000). Here, the CCLM mode determines the location of the luma pixels used to generate the linear relation between channels. In terms of optimizing coding efficiency, the video encoding device may determine the CCLM mode of the current chroma block.

The video encoding device may perform CCLM prediction based on the CCLM mode to generate a first predictor of the current chroma block (S4002).

The video encoding device generates a second predictor of the current chroma block by using information on adjacent blocks of the current chroma block and information on the other channel (S4004). Here, the other channel may be a luma channel or another chroma channel. Further, the information on the other channel includes information related to a corresponding region of the other channel.

The video encoding device may generate the second predictor by inferring a representative mode by using the information on the adjacent blocks of the current chroma block and the information on the other channel and then by performing an intra prediction by using the neighboring pixels of the current chroma block based on the representative mode. Here, the information on the adjacent blocks may include the width, height, aspect ratio, prediction mode, and the like of the neighboring blocks.

Alternatively, the video encoding device may generate the second predictor by inputting the adjacent pixels of the current chroma block into a deep learning-based neural network.

Alternatively, the video encoding device may determine a reference picture holding the co-located block of the current chroma block and may set the co-located block in the reference picture as the second predictor.

The video encoding device derives weights for the first predictor and the second predictor by using the information on the adjacent blocks of the current chroma block and the information on the other channel (S4006).

The video encoding device weighted-sums the first predictor and the second predictor by using the weights to generate a final predictor of the current chroma block (S4008).

The video encoding device encodes the CCLM mode of the current chroma block (S4010).

FIG. 41 is a flowchart of a method performed by the video decoding device for predicting a current chroma block, according to at least one embodiment of the present disclosure.

The video decoding device decodes the CCLM mode of the current chroma block from the bitstream (S4100). Here, the CCLM mode determines the locations of the luma pixels used to generate the linear relation between channels.

The video decoding device performs a CCLM prediction based on the CCLM mode to generate a first predictor of the current chroma block (S4102).

The video decoding device generates a second predictor of the current block by using information on adjacent blocks of the current chroma block and information on the other channel (S4104). Here, the other channel may be a luma channel or another chroma channel. Further, the information on the other channel includes information related to a corresponding region of the other channel.

The video decoding device may generate the second predictor by inferring a representative mode by using the information on the adjacent blocks of the current chroma block and the information on the other channel and then by performing an intra prediction that uses neighboring pixels of the current chroma block based on the representative mode. Here, the information on the adjacent blocks may include the width, height, aspect ratio, prediction mode, and the like of the neighboring blocks.

Alternatively, the video decoding device may generate the second predictor by inputting the adjacent pixels of the current chroma block into a deep learning-based neural network.

Alternatively, the video decoding device may determine a reference picture holding the co-located block of the current chroma block and may set the co-located block in the reference picture as the second predictor.

The video decoding device derives weights for the first predictor and the second predictor by using the information on the adjacent blocks of the current chroma block and motion information (S4106).

The video decoding device may calculate the weighted sum of the first predictor and the second predictor by using the weights to generate a final predictor of the current chroma block (S4108).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a video decoding device for predicting a current block, the method comprising:
decoding, from a bitstream, motion information that is of the current block and includes a reference picture index of the current block and a motion vector of the current block;
generating a first predictor of the current block by performing an inter prediction based on the motion information of the current block;
generating a second predictor of the current block by using information on adjacent blocks of the current block and the motion information of the current block;
deriving weights for the first predictor and the second predictor by using the information of the adjacent blocks of the current block and the motion information of the current block; and
generating a final predictor of the current block by weighted summing the first predictor and the second predictor by using the weights.

2. The method of claim 1, wherein generating the second predictor includes:
inferring a representative mode by using the information of the adjacent blocks of the current block and the motion information of the current block; and
generating the second predictor by performing an intra prediction that uses neighboring pixels of the current block based on the representative mode.

3. The method of claim 2, wherein inferring the representative mode includes:
setting as the representative mode a most frequent prediction mode that is derived from among intra-prediction modes of the adjacent blocks based on a block count.

4. The method of claim 2, wherein inferring the representative mode includes:
inferring the representative mode by using information on neighboring blocks in a region indicated by the motion vector of the current block.

5. The method of claim 2, wherein inferring the representative mode includes:
setting as the representative mode an intra-prediction mode of a block containing a pixel at a specific location within a region indicated by the motion vector of the current block.

6. The method of claim 2, wherein inferring the representative mode includes:
setting as the representative mode a most frequent intra-prediction mode derived based on a block count, among intra-prediction modes of blocks in a region indicated by the motion vector of the current block.

7. The method of claim 2, wherein inferring the representative mode includes:
setting as the representative mode a most frequent intra-prediction mode derived based on a block area, among intra-prediction modes of blocks in a region indicated by the motion vector of the current block.

8. The method of claim 2, wherein inferring the representative mode includes:
setting as the representative mode an intra-prediction mode of a block having an equal or most similar aspect ratio to the current block, among blocks in a region indicated by the motion vector of the current block.

9. The method of claim 2, wherein inferring the representative mode includes:
setting as the representative mode an intra-prediction mode corresponding to a direction most similar to the motion vector of the current block.

10. The method of claim 2, wherein deriving the weights includes:
deriving, on a block count basis, a proportion of adjacent blocks that use the representative mode among the adjacent blocks of the current block to derive the weights.

11. The method of claim 2, wherein deriving the weights includes:
deriving, on a block count basis, a proportion of blocks that use the representative mode among blocks included in a region indicated by the motion vector of the current block to derive the weights.

12. The method of claim 2, wherein deriving the weights includes:
deriving, on a block area basis, a proportion of blocks that use the representative mode among blocks included in a region indicated by the motion vector of the current block to derive the weights.

13. The method of claim 1, wherein generating the second predictor includes:
determining a reference picture that holds a co-located block of the current block; and
setting the co-located block in the reference picture to the second predictor.

14. The method of claim 13, wherein determining the reference picture includes:
determining as the reference picture a picture indicated by the reference picture index and used in generating the first predictor.

15. The method of claim 13, wherein determining the reference picture includes:
searching, among a preset number of pictures decoded before a current picture, a picture having a co-located template most similar to a template of the current block; and
determining a searched picture to be the reference picture.

16. A method performed by a video encoding device for predicting a current block, the method comprising:
determining motion information that is of the current block and includes a reference picture index of the current block and a motion vector of the current block;
generating a first predictor of the current block by performing an inter prediction based on the motion information of the current block;
generating a second predictor of the current block by using information on adjacent blocks of the current block and motion information of the current block;
deriving weights for the first predictor and the second predictor by using the information of the adjacent blocks of the current block and the motion information of the current block; and
generating a final predictor of the current block by weighted summing the first predictor and the second predictor by using the weights.

17. The method of claim 16, further comprising encoding the motion information of the current block.

18. The method of claim 16, wherein generating the second predictor includes:
inferring a representative mode by using the information of the adjacent blocks of the current block and the motion information of the current block; and
generating the second predictor by performing an intra prediction that uses neighboring pixels of the current block based on the representative mode.

19. A computer-readable recording medium storing a bitstream generated by a video encoding method, the video encoding method comprising:
determining motion information that is of a current block and includes a reference picture index of the current block and a motion vector of the current block;
generating a first predictor of the current block by performing an inter prediction based on the motion information of the current block;
generating a second predictor of the current block by using information on adjacent blocks of the current block and motion information of the current block;
deriving weights for the first predictor and the second predictor by using the information of the adjacent blocks of the current block and the motion information of the current block; and
generating a final predictor of the current block by weighted summing the first predictor and the second predictor by using the weights.
